(19) United States
(12) Patent Application Publication
(10) Pub. No.: US 2021/0155641 A1
(43) Pub. Date: May 27, 2021

(54) METHOD FOR PRODUCING PHOSPHINOBENZENE BORANE DERIVATIVE, METHOD FOR PRODUCING 1,2-BIS(DIALKYLPHOSPHINO)BENZENE DERIVATIVE, AND TRANSITION METAL COMPLEX

(71) Applicant: Nippon Chemical Industrial Co., Ltd., Tokyo (JP)

(72) Inventor: Ken Tamura, Tokyo (JP)

(73) Assignee: Nippon Chemical Industrial Co., Ltd., Tokyo (JP)

(21) Appl. No.: 17/058,221

(22) PCT Filed: May 20, 2019
(86) PCT No.: PCT/JP2019/019921

§ 371 Date: Nov. 24, 2020

(30) Foreign Application Priority Data
May 29, 2018 (JP) 2018-102380
Dec. 4, 2018 (JP) 2018-227506

(51) Int. Cl. C07F 9/50

(52) U.S. Cl. CPC C07F 9/5022

(57) ABSTRACT

A method for producing a phosphinobenzene borane derivative comprises a reaction step (A) of obtaining liquid A containing a 1,2-dihalogenobenzene represented by the following general formula (1):

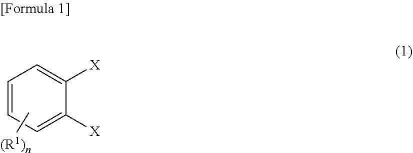

obtaining liquid B containing a phosphine borane compound obtained by deprotonating a hydrogen-phosphine borane compound represented by the following general formula (2):

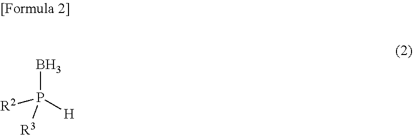

and then adding the liquid B to the liquid A to be allowed to react to thereby obtain the phosphinobenzene borane derivative represented by the following general formula (3):

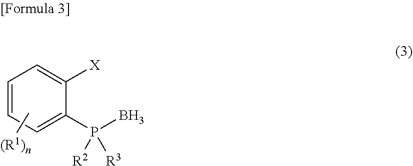

According to the present invention, there can be provided the industrially advantageous method for producing the phosphinobenzene borane derivative.

### TECHNICAL FIELD

The present invention relates to a method for producing a phosphinobenzene borane derivative. The present invention relates further to a method for producing a 1,2-bis(dialkylphosphino)benzene derivative useful as a ligand source or the like for a transition metal complex used as a ligand of a metal complex to be used as an asymmetric catalyst in asymmetric synthesis reactions.

### BACKGROUND ART

Organic synthesis reactions using, as a catalyst, a metal complex having an optically active phosphine ligand are known for long, and since being remarkably useful, are reported as many research results. In recent years, ligands whose phosphorus atom itself is asymmetric have been developed. For example, Patent Literature 1 and Non Patent Literature 1 describe an optically active 1,2-bis(dialkylphosphino)benzene derivative capable of providing a metal complex exhibiting excellent catalytic performance, and a method for producing the same.

The production method of Patent Literature 1 uses 1,2-bis(phosphino)benzene as a starting raw material. The production method of Non Patent Literature 1 uses a 1,2-difluorobenzenetricarbonylchromium and a bis(dialkylphosphino)boronium salt as starting substances.

Any of the starting substances used in the production methods described in Patent Literature 1 and Non Patent Literature 1, however, is expensive, and these production methods cannot be said to be industrially advantageous from the viewpoint of economic efficiency.

The present inventor, et al. earlier proposed, as an industrially advantageous method for producing an optically active 1,2-bis(dialkylphosphino)benzene derivative, a method for producing the optically active 1,2-bis(dialkylphosphino)benzene derivative from an optically active phosphinobenzene borane derivative represented by the following general formula (A):

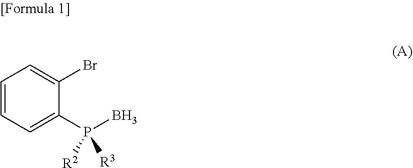

wherein R₁ and R₂ each denote a straight-chain or branched-chain alkyl group having 1 to 10 carbon atoms which may be substituted, a cycloalkyl group which may be substituted, or a phenyl group which may be substituted; and R₁ and R₂ are different groups.

### (see Patent Literature 2).

In Patent Literature 2, although the method for producing the optically active phosphinobenzene borane derivative represented by the above general formula (A) uses a 2-halogenoaniline as a starting raw material, since the process until a target phosphinobenzene borane derivative is obtained is long and additionally, the 2-halogenoaniline itself is expensive, the method is not industrially advantageous.

As an industrially advantageous method for producing a phosphinobenzene borane derivative represented by the above general formula (A), a method using a 1,2-dihalogenobenzene as a starting raw material is proposed (Patent Literature 3 and Non Patent Literature 2).

However, even if the reaction is carried out at an ultralow temperature of −80° C., the yield of, particularly, an optically active phosphinobenzene borane derivative is low; for inexpensively and industrially advantageously producing an optically active 1,2-bis(dialkylphosphino)benzene derivative useful as a ligand source or the like for a transition metal complex used as a ligand of a metal complex to be used as an asymmetric catalyst, also in the optically active phosphinobenzene borane derivative to become a starting raw material therefor, a further improvement in the yield is demanded.

### CITATION LIST

### Patent Literature

Patent Literature 1: Japanese Patent Laid-Open No. 2000-319288
Patent Literature 2: Japanese Patent Laid-Open No. 2012-017288
Patent Literature 3: International Publication No. WO2013/007724

### Non Patent Literature

Non Patent Literature 1: ORGANIC LETTERS, 2006, Vol. 8, No. 26, 6103-6106
Non Patent Literature 2: ORGANIC LETTERS, 2010, Vol. 12, No. 19, 4400-4403

### SUMMARY OF INVENTION

### Technical Problem

Therefore, an object of the present invention is to provide an industrially advantageous method for producing a phosphinobenzene borane derivative. Further an object of the present invention is, in the case of producing an optically active phosphinobenzene borane derivative and 1,2-bis(dialkylphosphino)benzene derivative, to provide methods of being capable of producing the optically active phosphinobenzene borane derivative and 1,2-bis(dialkylphosphino)benzene derivative high in optical purity, in high yields.

### Solution to Problem

As a result of exhaust studies in consideration of the above actual situation, the present inventor, et al. have found that by adding liquid B containing a phosphine borane compound obtained by deprotonating a hydrogen-phosphine borane compound represented by a specific general formula to liquid A containing a 1,2-dihalogenobenzene represented by a specific general formula, since impurities accompanying side reactions can be reduced as compared with the conventional method of adding the liquid A to the liquid B, the yield of a phosphinobenzene borane derivative is remarkably improved; and also in the case of producing an optically active phosphinobenzene borane derivative, even if the reaction is carried out at an industrially advantageous temperature, the optically active phosphinobenzene borane derivative high in optical purity can be obtained in a high yield. This finding has led to the completion of the present invention.

That is, the present invention (aspect 1) is to provide a method for producing a phosphinobenzene borane derivative, the method comprising a reaction step (A) of: obtaining liquid A comprising a 1,2-dihalogenobenzene represented by the following general formula (1):

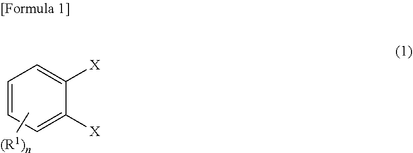

wherein X denotes a halogen atom; R¹ denotes a monovalent substituent; and n denotes an integer of 0 to 4; and obtaining liquid B comprising a phosphine borane compound obtained by deprotonating a hydrogen-phosphine borane compound represented by the following general formula (2):

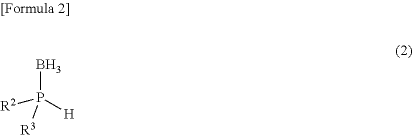

wherein R² and R³ each denote a straight-chain or branched-chain alkyl group having 1 to 10 carbon atoms which may be substituted, a cycloalkyl group which may be substituted, or a phenyl group which may be substituted; and R² and R³ may be the same or different; and then adding the liquid B to the liquid A to be allowed to react to thereby obtain the phosphinobenzene borane derivative represented by the following general formula (3):

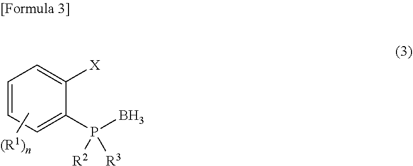

wherein R¹, R², R³, X and n have the same meanings as defined above.

The present invention (aspect 2) is further to provide the method for producing a phosphinobenzene borane derivative according to the aspect 1, wherein the hydrogen-phosphine borane compound represented by the above general formula (2) is an optically active substance having an asymmetric center on the phosphorus atom.

The present invention (aspect 3) is further to provide the method for producing a bisphosphinobenzene borane derivative according to the aspect 1 or 2, wherein R² is a t-butyl group, a 1,1,3,3-tetramethylbutyl group or an adamantyl group; and R³ is a methyl group.

The present invention (aspect 4) is further to provide the method for producing a bisphosphinobenzene borane derivative according to the aspect 2 or 3, wherein the reaction temperature in the reaction step (A) is −80 to 30° C.

The present invention (aspect 5) is further to provide a method for producing a 1,2-bis(dialkylphosphino)benzene derivative, the method comprising:

a reaction step (A) of:

obtaining liquid A comprising a 1,2-dihalogenobenzene represented by the following general formula (1):

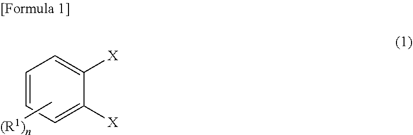

wherein X denotes a halogen atom; R¹ denotes a monovalent substituent; and n denotes an integer of 0 to 4;
obtaining liquid B comprising a phosphine borane compound obtained by deprotonating a hydrogen-phosphine borane compound represented by the following general formula (2):

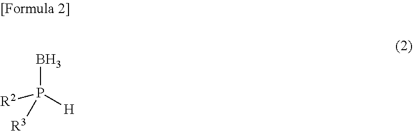

wherein R² and R³ each denote a straight-chain or branched-chain alkyl group having 1 to 10 carbon atoms which may be substituted, a cycloalkyl group which may be substituted, or a phenyl group which may be substituted; and R² and R³ may be the same or different; and then adding the liquid B to the liquid A to be allowed to react to thereby obtain a phosphinobenzene borane derivative represented by the following general formula (3):

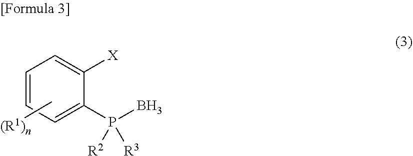

wherein R¹, R², R³, X and n have the same meanings as defined above; and

the following reaction step (B1), reaction step (B2) or reaction step (B3) of obtaining the 1,2-bis(dialkylphosphino)benzene derivative represented by the following general formula (6):

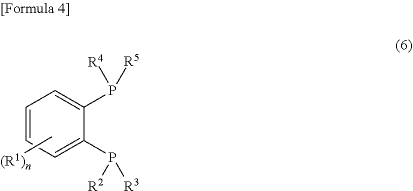

wherein R¹, R², R³, X and n have the same meanings as defined above; and R⁴ and R⁵ each denote a straight-chain or branched-chain alkyl group having 1 to 10 carbon atoms which may be substituted, a cycloalkyl group which may be substituted, or a phenyl group which may be substituted; and R⁴ and R⁵ may be the same or different

by carrying out the reaction step (B1), the reaction step (B2) or the reaction step (B3):
the reaction step (B1): a step of deboranating the phosphinobenzene borane derivative represented by the general formula (3), then lithiating the resultant, then reacting the resultant with an alkyldihalogenophosphine represented by the general formula (4):

R^{a}PX¹₂ (4)

wherein R^{a} is one of R⁴ and R⁵ in the general formula (6); and X¹ denotes a halogen atom,
and then reacting the resultant with a Grignard reagent represented by the general formula (5):

R^{b}MgX² (5)

wherein R^{b} is the other of R⁴ and R⁵ in the general formula (6); and X² denotes a halogen atom; the reaction step (B2): a step of deboranating the phosphinobenzene borane derivative represented by the general formula (3), then lithiating the resultant, then reacting the resultant with a dialkylhalogenophosphine represented by the general formula (4′):

R^{c}₂PX³ (4′)

wherein R^{c} is a group equivalent to R⁴ and R⁵ in the case of being the same in the general formula (6); and X³ denotes a halogen atom; and
the reaction step (B3): a step of lithiating the phosphinobenzene borane derivative represented by the general formula (3), then reacting the resultant with a dialkylhalogenophosphine represented by the general formula (4′):

R^{c}₂PX³ (4′)

wherein R^{c} is a group equivalent to R⁴ and R⁵ in the case of being the same in the general formula (6); and X³ denotes a halogen atom, and then deboranating the resultant.

The present invention (aspect 6) is further to provide the method for producing a 1,2-bis(dialkylphosphino)benzene derivative according to the aspect 5, wherein the hydrogen-phosphine borane compound represented by the general formula (2) is an optically active substance having an asymmetric center on the phosphorus atom.

The present invention (aspect 7) is further to provide an (R)-1-dialkylphosphino-2-diphenylphosphinobenzene represented by the following general formula (7):

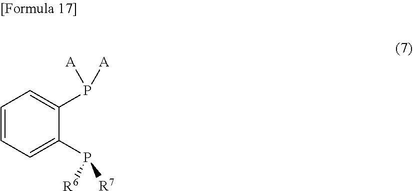

wherein R⁶ and R⁷ each denote a straight-chain or branched-chain alkyl group having 1 to 10 carbon atoms which may be substituted, or a cycloalkyl group which may be substituted, provided R⁶ and R⁷ are not the same group; and A denotes a phenyl group which may be substituted.

The present invention (aspect 8) is further to provide (R)-1-tert-butylmethylphosphino-2-diphenylphosphinobenzene represented by the following general formula (8):

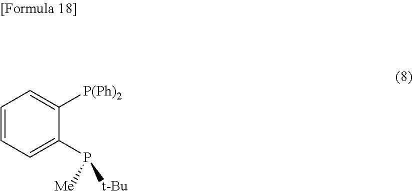

The present invention (aspect 9) is further to provide an (R)-dialkylphosphino-2-bis(pentafluorophenyl)phosphinobenzene represented by the following general formula (9):

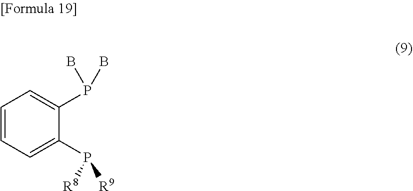

wherein R⁸ and R⁹ each denote a straight-chain or branched-chain alkyl group having 1 to 10 carbon atoms which may be substituted, or a cycloalkyl group which may be substituted, provided R⁸ and R⁹ are not the same group; and B denotes a pentafluorophenyl group which may be substituted.

The present invention (aspect 10) is further to provide (R)-1-tert-butylmethylphosphino-2-bis(pentafluorophenyl)phosphinobenzene represented by the following general formula (10):

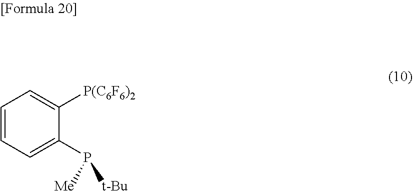

The present invention (aspect 11) is further to provide a transition metal complex comprising a transition metal and a compound according to any one of the aspects 7 to 10 coordinating to the transition metal.

The present invention (aspect 12) is further to provide the transition metal complex according to the aspect 11, being used as a catalyst in an asymmetric synthesis reaction.

### Advantageous Effects of Invention

The method for producing a phosphinobenzene borane derivative according to the present invention can remarkably improve the yield thereof, and, in the case of producing an optically active phosphinobenzene borane derivative, can provide the optically active phosphinobenzene borane derivative high in optical purity, in a high yield even if the reaction is carried out at an industrially advantageous temperature. Further the method for producing a 1,2-bis(dialkylphosphino)benzene derivative according to the present invention can industrially advantageously provide the 1,2-bis(dialkylphosphino)benzene derivative useful as a ligand source for a transition metal complex used as a ligand of a metal complex to be used as an asymmetric catalyst in an asymmetric synthesis reaction.

### DESCRIPTION OF EMBODIMENTS

The method for producing a phosphinobenzene borane derivative according to the present invention comprises a reaction step (A) of:

obtaining liquid A comprising a 1,2-dihalogenobenzene represented by the following general formula (1):

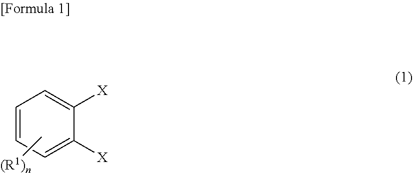

wherein X denotes a halogen atom; R¹ denotes a monovalent substituent; and n denotes an integer of 0 to 4; and
obtaining liquid B comprising a phosphine borane compound obtained by deprotonating a hydrogen-phosphine borane compound represented by the following general formula (2):

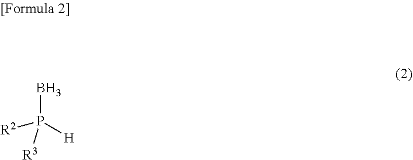

wherein R² and R³ each denote a straight-chain or branched-chain alkyl group having 1 to 10 carbon atoms which may be substituted, a cycloalkyl group which may be substituted, or a phenyl group which may be substituted; and R² and R³ may be the same or different; and then adding the liquid B to the liquid A to be allowed to react to thereby obtain the phosphinobenzene borane derivative represented by the following general formula (3):

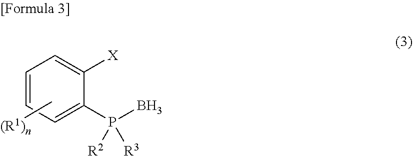

wherein R¹, R², R³, X and n have the same meanings as defined above.

The method for producing a phosphinobenzene borane derivative according to the present invention comprises the reaction step (A) of adding liquid B comprising a phosphine borane compound obtained by deprotonating a hydrogen-phosphine borane compound represented by the above general formula (2) to liquid A comprising a 1,2-dihalogenobenzene represented by the above general formula (1) to be allowed to react to thereby obtain the phosphinobenzene borane derivative represented by the general formula (3). Here, in the present invention, adding the liquid B to the liquid A refers to such an addition manner that the liquid B is little by little dividedly added to the total amount of the liquid A.

The reaction step (A) adopts such addition manner that the liquid B is added to the liquid A. Then, in the reaction step (A), by adding the liquid B to the liquid A, as compared with the conventional method of adopting such an addition manner that the liquid A is added to the liquid B, the yield of the phosphinobenzene borane derivative can be raised.

In the reaction step (A), first, there are separately prepared the liquid A comprising a 1,2-dihalogenobenzene represented by the general formula (1) and the liquid B comprising a phosphine borane compound obtained by deprotonating a hydrogen-phosphine borane compound represented by the general formula (2).

The liquid A relevant to the reaction step (A) is a liquid comprising a 1,2-dihalogenobenzene represented by the general formula (1). The liquid A may be a solution in which a 1,2-dihalogenobenzene represented by the general formula (1) is dissolved in a solvent, or may be a slurry in which a solid 1,2-dihalogenobenzene represented by the general formula (1) is dispersed in a solvent.

In the general formula (1), X is a halogen atom, and examples thereof include a chlorine atom, a bromine atom and an iodine atom. X is preferably a bromine atom. In the general formula (1), R¹ denotes a monovalent substituent. The monovalent substituent of R¹ is not especially limited, but examples thereof include straight-chain or branched-chain alkyl groups having 1 to 5 carbon atoms, a nitro group, substituted amino groups, an amino group, alkoxy groups, a hydroxyl group, alkylenedioxy groups, a fluoro group, a chloro group, a bromo group and an iodo group. In the general formula (1), n denotes an integer of 0 to 4.

As the 1,2-dihalogenobenzene represented by the general formula (1), commercially available products can be used, and for example, 1,2-dibromobenzene is available from Tokyo Chemical Industry Co., Ltd.

The kind of the solvent to be used for the liquid A is not especially limited as long as being a solvent inactive to a 1,2-dihalogenobenzene represented by the general formula (1). The solvent to be used for the liquid A is preferably one which can dissolve the 1,2-dihalogenobenzene represented by the general formula (1), and examples of such a solvent include tetrahydrofuran, N,N-dimethylformamide, diethyl ether, cyclopentyl methyl ether, 1,2-dimethoxyethane, dioxane, hexane and toluene. These solvents are used singly or as a mixed solvent thereof. In the reaction step (A), even when the liquid A is a slurry in which the 1,2-dihalogenobenzene represented by the general formula (1) is present in a slurry state, the reaction can be initiated. Hence, the solvent to be used for the liquid A does not necessarily need completely dissolving the 1,2-dihalogenobenzene represented by the general formula (1), and may be a solvent forming a slurry of the 1,2-dihalogenobenzene represented by the general formula (1).

The concentration of the 1,2-dihalogenobenzene represented by the general formula (1) in liquid A is, from the viewpoint of the reactivity and the productivity, preferably 1 to 50% by mass, and especially preferably 10 to 90% by mass.

The liquid B relevant to the reaction step (A) is a solution containing a phosphine borane compound obtained by deprotonating a hydrogen-phosphine borane compound represented by the general formula (2) in a solvent.

In the general formula (2), R² and R³ each denote a straight-chain or branched-chain alkyl group having 1 to 10 carbon atoms which may be substituted, a cycloalkyl group which may be substituted, or a phenyl group which may be substituted; and R² and R³ may be the same or different.

Examples of the alkyl group denoted by R² and R³ include a methyl group, an ethyl group, an isopropyl group, an n-propyl group, an isobutyl group, an n-butyl group, a sec-butyl group, a tert-butyl group, an isoheptyl group, an n-heptyl group, an isohexyl group and an n-hexyl group. The cycloalkyl group denoted by R² and R³ includes a cyclopentyl group and a cyclohexyl group. When R² and/or R³ is a cycloalkyl group having a substituent or a phenyl group having a substituent, the substituent includes alkyl groups, alkoxy groups, a nitro group, an amino group, a hydroxyl group, a fluoro group, a chloro group, a bromo group and an iodo group. When R² and/or R³ is an alkyl group having a substituent, the substituent includes a phenyl group, alkoxy groups, a nitro group, an amino group, a hydroxyl group, a fluoro group, a chloro group, a bromo group and an iodo group.

In the method for producing a phosphinobenzene borane derivative according to the present invention, from the viewpoint of using the 1,2-bis(dialkylphosphino)benzene derivative as an application of an asymmetric catalyst, it is preferable that the hydrogen-phosphine borane compound represented by the general formula (2) is an optically active substance having an asymmetric center on the phosphorus atom; and it is especially preferable that R² in the general formula (2) is a t-butyl group, a 1,1,3,3-tetramethylbutyl group or an adamantyl group, and R³ is a methyl group. When the hydrogen-phosphine borane compound represented by the general formula (2) is an optically active substance having an asymmetric center on the phosphorus atom, it may be an (R) isomer or may be an (S) isomer. It is preferable that the optical purity of the hydrogen-phosphine borane compound represented by the general formula (2) is high, and for example, being 98% ee or higher is preferable. In the method for producing a phosphinobenzene borane derivative according to the present invention, not using a racemate as the hydrogen-phosphine borane compound represented by the general formula (2) is preferable from the viewpoint of providing an optically high purity phosphinobenzene borane derivative containing no isomers other than the target optically active substance.

The hydrogen-phosphine borane compound represented by the general formula (2) is prepared by a well-known method. Examples of such a method include methods described in Japanese Patent Laid-Open Nos. 2001-253889, 2003-300988, 2007-70310 and 2010-138136, and J. Org. Chem. 2000, vol. 65, pp. 4185-4188.

In the preparation of the liquid B, a solution in which a hydrogen-phosphine borane compound represented by the general formula (2) is dissolved in a solvent, and a base are mixed to deprotonate the hydrogen-phosphine borane compound represented by the general formula (2) to thereby prepare the liquid B. At this time, adding the base to the solution in which a hydrogen-phosphine borane compound represented by the general formula (2) is dissolved in a solvent is preferable in the advantageous point of reducing by-products, because reaction products are not continuously exposed to the excess base as compared with the case of adding the solution in which a hydrogen-phosphine borane compound represented by the general formula (2) is dissolved in a solvent to the base solution. Here, in the present invention, adding the base to the solution in which a hydrogen-phosphine borane compound represented by the general formula (2) is dissolved in a solvent refers to such an addition manner that the base is little by little dividedly added to the total amount of the solution in which a hydrogen-phosphine borane compound represented by the general formula (2) is dissolved in a solvent.

In the preparation of the liquid B, the concentration of the hydrogen-phosphine borane compound represented by the general formula (2) in the solvent is, from the viewpoint of the reactivity and the productivity, preferably 1 to 30% by mass, and especially preferably 5 to 20% by mass.

In the preparation of the liquid B, examples of the base to be used in the deprotonation include n-butyllithium, lithium diisopropylamide, methylmagnesium bromide, t-butoxypotassium, Hunig base, potassium hydroxide and sodium hydroxide. As the base to be used for the deprotonation, n-butyllithium is preferable.

In the preparation of the liquid B, the amount of the base added to the hydrogen-phosphine borane compound represented by the general formula (2) is, from the viewpoint of the economic efficiency and the reactivity, preferably 1.0 to 1.5 in molar ratio.

In the preparation of the liquid B, the solvent to be used in the deprotonation is not especially limited as long as being capable of dissolving the hydrogen-phosphine borane compound represented by the general formula (2) and the phosphine borane compound to be produced, and being inactive to the hydrogen-phosphine borane compound represented by the general formula (2) and the phosphine borane compound to be produced. In the preparation of the liquid B, examples of the solvent to be used in the deprotonation include tetrahydrofuran, N,N-dimethylformamide, diethyl ether, cyclopentyl methyl ether, 1,2-dimethoxyethane, dioxane, hexane and toluene. These solvents are used singly or as a mixed solvent thereof.

In the preparation of the liquid B, the addition temperature of the base is, from the viewpoint of being capable of deprotonation with the optical purity of the hydrogen-phosphine borane compound represented by the general formula (2) being kept, preferably −80° C. to 30° C., and especially preferably −20° C. to 0° C. In the preparation of the liquid B, although the deprotonation of a hydrogen-phosphine borane compound represented by the general formula (2) is fast carried out by adding the base to the liquid containing the hydrogen-phosphine borane compound represented by the general formula (2), as required, in order to complete the deprotonation reaction, maturation may be carried out following the finish of the addition of the base. Here, in the present invention, the maturation refers to making the reaction to continue in order to complete the reaction after the mixing of the total amount of the reaction raw materials.

Then in the preparation of the liquid B, by adding a base to the liquid containing a hydrogen-phosphine borane compound represented by the general formula (2), a deprotonated substance of the hydrogen-phosphine borane compound represented by the general formula (2) is produced to thereby obtain the liquid B containing a phosphine borane compound obtained by deprotonating the hydrogen-phosphine borane compound represented by the general formula (2).

In the reaction step (A), either of the preparation of the liquid A and the preparation of the liquid B, that is, the deprotonation treatment of the hydrogen-phosphine borane compound represented by the general formula (2), may be carried out first, or may be carried out simultaneously in parallel.

In the reaction step (A), then, the liquid B is added to the liquid A. The method for producing a phosphinobenzene borane derivative according to the present invention has a characteristic in that the reaction is carried out by adding the liquid B to the liquid A, and since being capable of reducing impurities accompanying side reactions as compared with a conventional method of adding the liquid A to the liquid B, can remarkably improve the yield. Further the method for producing a phosphinobenzene borane derivative according to the present invention, also in the case of producing an optically active phosphinobenzene borane derivative, by adding the liquid B to the liquid A for the reaction, even if the reaction temperature is raised to an industrially advantageous temperature, can produce the optically active phosphinobenzene borane derivative high in optical purity in a high yield.

In the reaction step (A), the temperature of the liquid A at the time point of initiating the addition of the liquid B to the liquid A is, for the reason that with sufficient reactivity, a product high in optical purity can be obtained, preferably −80° C. to 80° C., and especially preferably −20° C. to 50° C. Further when a desired optically active phosphinobenzene borane derivative is produced by using an optically active substance as the hydrogen-phosphine borane compound represented by the general formula (2), the temperature of the liquid A at the time point of initiating the addition of the liquid B to the liquid A is, from the viewpoint of obtaining the optically active phosphinobenzene borane derivative high in optical purity in a high yield, preferably −80° C. to 30° C., and especially preferably −20° C. to 0° C.

In the reaction step (A), the total amount of the liquid B to be added to the liquid A is, from the viewpoint of the reactivity and the economic efficiency, such an amount that the molar ratio of the phosphine borane compound being a deprotonated substance of the hydrogen-phosphine borane compound represented by the general formula (2) with respect to the 1,2-dihalogenobenzene represented by the general formula (1) in liquid A becomes preferably 1.0 to 3.0, and especially preferably 1.1 to 2.0.

In the reaction step (A), the addition temperature when the liquid B is added to the liquid A, that is, the temperature of the reaction liquid when the liquid B is added to the liquid A is, from the viewpoint of carrying out the reaction at an industrially advantageous reaction temperature, preferably −80° C. to 80° C., and especially preferably −20° C. to 50° C. Further when a desired optically active phosphinobenzene borane derivative is produced by using an optically active substance as the hydrogen-phosphine borane compound represented by the general formula (2), the addition temperature when the liquid B is added to the liquid A, that is, the temperature of the reaction liquid when the liquid B is added to the liquid A is, from the viewpoint of obtaining the optically active phosphinobenzene borane derivative high in optical purity in a high yield, preferably −80° C. to 30° C., and especially preferably −20° C. to 0° C.

In the reaction step (A), the addition rate of the liquid B to the liquid A is not especially limited, but is, from the viewpoint of obtaining a stable quality phosphinobenzene borane derivative, preferably a constant rate. For example, from the viewpoint of the control of the reaction heat and the side reactions, it is preferable that the addition of the liquid B to the liquid A is, for example in the case of a 1-L scale, carried out over 10 min or longer; more preferable, over 30 min or longer. The addition of the liquid B to the liquid A may be continuous or intermittent. Whether the addition of the liquid B to the liquid A is continuous or intermittent, it is preferable, from the viewpoint of the production time, that for example, in the case of a 1-L scale, the addition of the liquid B to the liquid A is carried out in a time of 180 min or shorter. During the addition of the liquid B to the liquid A, it is preferable that the temperature of the reaction liquid is held in the above preferable range of the addition temperature of the liquid B to the liquid A.

In the reaction step (A), when the reaction is more quickly completed by the addition of the liquid B to the liquid A, since the reaction is completed along with the finish of the addition of the liquid B to the liquid A, after the addition of the liquid B to the liquid A is finished, the reaction is made to be quickly finished. In the reaction step (A), after the finish of the addition of the liquid B to the liquid A, as required, in order to successively complete the reaction, maturation can be carried out. The temperature of the reaction liquid when the maturation is carried out is −80° C. to 80° C., and is, from the viewpoint of carrying out the maturation at an industrially advantageous reaction temperature, preferably −20° C. to 80° C. Further when a desired optically active phosphinobenzene borane derivative is produced by using an optically active substance as the hydrogen-phosphine borane compound represented by the general formula (2), the temperature of the reaction liquid in the maturation is, from the viewpoint of obtaining the optically active phosphinobenzene borane derivative high in optical purity in a high yield, preferably −20° C. to 50° C., and especially preferably −20° C. to 30° C. The time of the maturation is, from the viewpoint of preventing decomposition of the product, preferably, for example, 10 min or longer and 5 hours or shorter. Here, in the reaction step (A), when after the addition of the liquid B to the liquid A, the reaction is finished without the maturation, the temperature of the reaction liquid from the initiation of the addition of the liquid B to the liquid A until the finish of the addition is the reaction temperature; and when after the addition of the liquid B to the liquid A is carried out, the maturation is carried out, the temperature of the reaction liquid from the initiation of the addition of the liquid B to the liquid A until the finish of the maturation is the reaction temperature. Hence, in the reaction step (A), the reaction temperature when the 1,2-dihalogenobenzene represented by the general formula (1) and the phosphine borane compound obtained by deprotonating the hydrogen-phosphine borane compound represented by the general formula (2) are allowed to react is −80° C. to 80° C. and is, from the viewpoint that the maturation is carried out at an industrially advantageous temperature, preferably −20° C. to 80° C. Further when a desired optically active phosphinobenzene borane derivative is produced by using an optically active substance as the hydrogen-phosphine borane compound represented by the general formula (2), in the reaction step (A), the reaction temperature when the 1,2-dihalogenobenzene represented by the general formula (1) and the phosphine borane compound obtained by deprotonating the hydrogen-phosphine borane compound represented by the general formula (2) are allowed to react is, from the viewpoint of obtaining the optically active phosphinobenzene borane derivative high in optical purity in a high yield, preferably −20° C. to 50° C., and especially preferably −20° C. to 30° C.

In the reaction step (A), the liquid B is added to the liquid A and the 1,2-dihalogenobenzene represented by the general formula (1) and the phosphine borane compound obtained by deprotonating the hydrogen-phosphine borane compound represented by the general formula (2) are allowed to react to thereby obtain the phosphinobenzene borane derivative represented by the general formula (3).

In the reaction step (A), after the finish of the reaction, the produced phosphinobenzene borane derivative represented by the general formula (3), as required, may be subjected to a refining operation such as separatory cleaning, extraction, crystallization, distillation, sublimation or column chromatography.

The phosphinobenzene borane derivative represented by the general formula (3) obtained by the method for producing a phosphinobenzene borane derivative according to the present invention is useful as a production raw material of a 1,2-bis(dialkylphosphino)benzene derivative represented by the general formula (6).

As a method for producing the 1,2-bis(dialkylphosphino)benzene derivative represented by the general formula (6) from the phosphinobenzene borane derivative represented by the general formula (3), the following method for producing a 1,2-bis(dialkylphosphino)benzene derivative according to the present invention is preferable from the viewpoint of being capable of being continuously carried out and being industrially advantageous.

The method for producing a 1,2-bis(dialkylphosphino)benzene derivative according to the present invention comprises:

a reaction step (A) of:

obtaining liquid A comprising a 1,2-dihalogenobenzene represented by the following general formula (1):

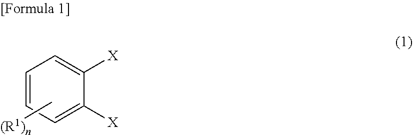

wherein X denotes a halogen atom; R¹ denotes a monovalent substituent; and n denotes an integer of 0 to 4;
obtaining liquid B comprising a phosphine borane compound obtained by deprotonating a hydrogen-phosphine borane compound represented by the following general formula (2):

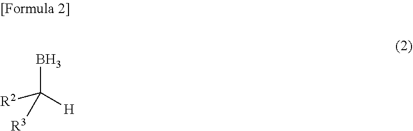

wherein R² and R³ each denote a straight-chain or branched-chain alkyl group having 1 to 10 carbon atoms which may be substituted, a cycloalkyl group which may be substituted, or a phenyl group which may be substituted; and R₂ and R₃ may be the same or different, and then adding the liquid B to the liquid A to be allowed to react to thereby obtain a phosphinobenzene borane derivative represented by the following general formula (3):

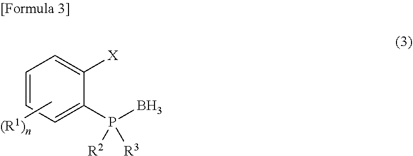

wherein R¹, R², R³, X and n have the same meanings as defined above; and

the following reaction step (B1), reaction step (B2) or reaction step (B3) of obtaining the 1,2-bis(dialkylphosphino)benzene derivative represented by the following general formula (6):

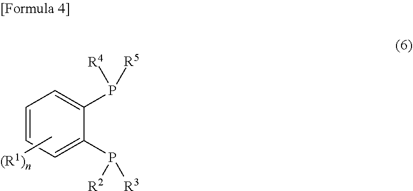

wherein R¹, R², R³, X and n have the same meanings as defined above; and R⁴ and R⁵ each denote a straight-chain or branched-chain alkyl group having 1 to 10 carbon atoms which may be substituted, a cycloalkyl group which may be substituted, or a phenyl group which may be substituted; and R⁴ and R⁵ may be the same or different by carrying out the reaction step (B1), the reaction step (B2) or the reaction step (B3):
the reaction step (B1): a step of deboranating the phosphinobenzene borane derivative represented by the general formula (3), then lithiating the resultant, then reacting the resultant with an alkyldihalogenophosphine represented by the general formula (4):

R^{a}PX¹₂ (4)

wherein R^{a} is one of R⁴ and R⁵ in the general formula (6); and X¹ denotes a halogen atom,
and then reacting the resultant with a Grignard reagent represented by the general formula (5):

R^{b}MgX² (5)

wherein R^{b} is the other of R⁴ and R in the general formula (6); and X² denotes a halogen atom;
the reaction step (B2): a step of deboranating the phosphinobenzene borane derivative represented by the general formula (3), then lithiating the resultant, then reacting the resultant with a dialkylhalogenophosphine represented by the general formula (4′):

R^{c}₂PX³ (4′)

wherein R^{c} is a group equivalent to R⁴ and R⁵ in the case of being the same in the general formula (6); and X³ denotes a halogen atom; and
the reaction step (B3): a step of lithiating the phosphinobenzene borane derivative represented by the general formula (3), then reacting the resultant with a dialkylhalogenophosphine represented by the general formula (4′):

R^{c}₂PX³ (4′)

wherein R^{c} is a group equivalent to R⁴ and R⁵ in the case of being the same in the general formula (6); and X³ denotes a halogen atom, and then deboranating the resultant.

That is, in the method for producing a 1,2-bis(dialkylphosphino)benzene derivative according to the present invention, after the reaction step (A) is carried out, the reaction step (B1) is carried out by using a phosphinobenzene borane derivative obtained by carrying out the reaction step (A) to thereby obtain the 1,2-bis(dialkylphosphino)benzene derivative represented by the general formula (6); or after the reaction step (A) is carried out, the reaction step (B2) is carried out by using a phosphinobenzene borane derivative obtained by carrying out the reaction step (A) to thereby obtain the 1,2-bis(dialkylphosphino)benzene derivative represented by the general formula (6); or after the reaction step (A) is carried out, the reaction step (B3) is carried out by using a phosphinobenzene borane derivative obtained by carrying out the reaction step (A) to thereby obtain the 1,2-bis(dialkylphosphino)benzene derivative represented by the general formula (6).

Here, in the method for producing a 1,2-bis(dialkylphosphino)benzene derivative according to the present invention, R^{a} in the general formula (4) is one of R⁴ and R⁵ in the general formula (6); and R^{b} in the general formula (5) is the other of R⁴ and R⁵ in the general formula (6). That is, when in a reaction (iii), an alkyldihalogenophosphine represented by R⁴PX¹₂ is used as the alkyldihalogenophosphine represented by the general formula (4), in a reaction (iv), a Grignard regent represented by R⁵MgX² is used as the Grignard regent represented by the general formula (5); whereas when in the reaction (iii), an alkyldihalogenophosphine represented by R⁵PX¹₂ is used as the alkyldihalogenophosphine represented by the general formula (4), in the reaction (iv), a Grignard regent represented by R⁴MgX² is used as the Grignard regent represented by the general formula (5).

Then, R^{c} in the general formula (4′) is a group equivalent to R⁴ and R⁵ in the case of being the same in the general formula (6).

Hereinafter, the method having the reaction step (B1) for producing a 1,2-bis(dialkylphosphino)benzene derivative is referred to as “production method B1”. On the other hand, the method having the reaction step (B2) for producing a 1,2-bis(dialkylphosphino)benzene derivative is referred to as “production method B2” in some cases. Then, the method having the reaction step (B3) for producing a 1,2-bis(dialkylphosphino)benzene derivative is referred to as “production method B3” in some cases.

The method for producing a 1,2-bis(dialkylphosphino)benzene derivative relevant to the production method B1 according to the present invention comprises a reaction step (A) of adding liquid B containing a phosphine borane compound obtained by deprotonating a hydrogen-phosphine borane compound represented by the general formula (2) to liquid A containing a 1,2-dihalogenobenzene represented by the general formula (1) to be allowed to react to thereby obtain a phosphinobenzene borane derivative represented by the general formula (3), and a reaction step (B1) of deboranating the phosphinobenzene borane derivative represented by the general formula (3), then lithiating the resultant, then reacting the resultant with an alkyldihalogenophosphine represented by the general formula (4), and then reacting the resultant with a Grignard regent represented by the general formula (5) to thereby obtain the 1,2-bis(dialkylphosphino)benzene derivative represented by the general formula (6).

The reaction step (A) relevant to the production method B1 of the 1,2-bis(dialkylphosphino)benzene derivative according to the present invention is the same as the reaction step (A) relevant to the method for producing a phosphinobenzene borane derivative according to the present invention.

The reaction step (B1) comprises deboranation (i), lithiation (ii), the reaction (iii) of a reaction product after the deboranation and the lithiation with an alkyldihalogenophosphine, and the reaction (iv) of a reaction product obtained by the reaction (iii) with a Grignard regent.

In the deboranation (i), according to the following reaction formula (1), a deboranation reaction of a phosphinobenzene borane derivative represented by the general formula (3) is carried out in a solvent by a deboranating agent to thereby obtain a phosphinobenzene derivative represented by the general formula (3A) in the reaction formula (1).

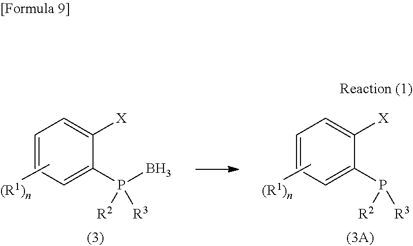

wherein R¹, R², R³, X and n have the same meanings as defined above.

Examples of the deboranating agent to be used for the deboranation (i) include N,N,N′,N′-tetramethylethylenediamine (TMEDA), triethylenediamine (DABCO), triethyleneamine, HBF₄ and trifluoromethanesulfonic acid. As the deboranating agent, DABCO is preferable. The amount of the deboranating agent to be added is, with respect to 1 mol of the phosphinobenzene borane derivative represented by the general formula (3), usually 1.0 to 3.0 mol, and preferably 1.1 to 2.0 mol.

Examples of the solvent to be used in the deboranation (i) include THF, hexane, toluene, 1,2-dimethoxyethane, tetrahydrofuran, diethyl ether, cyclopentyl methyl ether and dioxane. These may be used singly or as a mixture of two or more.

The reaction temperature of the deboranation reaction in the deboranation (i) is, from the viewpoint of obtaining the phosphinobenzene derivative (3A) high in optical purity, preferably 20 to 120° C., and more preferably 30 to 80° C. The reaction time of the deboranation reaction in the deboranation (i) is preferably 10 min or longer, especially preferably 0.5 to 10 hours, and more preferably 1 to 8 hours.

In the lithiation (ii), according to the following reaction formula (2), the lithiation of the phosphinobenzene derivative represented by the general formula (3A) is carried out in a solvent by a lithiating agent to thereby obtain a reaction product represented by the general formula (3B) in the reaction formula (2). In the reaction step (B), the lithiation can be carried out continuously from the deboranation.

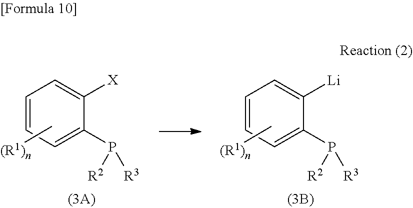

wherein R¹, R², R³, X and n have the same meanings as defined above.

As the lithiating agent to be used in the lithiation (ii), for example, an organolithium compound is used. Examples of the organolithium compound include methyllithium, ethyllithium, n-propyllithium, sec-propyllithium, n-butyllithium, sec-butyllithium and tert-butyllithium. The amount of the lithiating agent to be added is, in the molar ratio of the lithiating agent with respect to the phosphinobenzene derivative represented by the general formula (3A), preferably 1.0 to 1.5 from the viewpoint of the economic efficiency and the reactivity, and more preferably 1.0 to 1.2 from the viewpoint of controlling side reactions.

Examples of the solvent to be used in the lithiation (ii) include THF, hexane, toluene, 1,2-dimethoxyethane, tetrahydrofuran, diethyl ether, cyclopentyl methyl ether and dioxane, and these may be used singly or as a mixture of two or more.

In the lithiation (ii), the addition temperature when the lithiating agent is added, that is, the temperature of the reaction liquid when the lithiating agent is added is, from the viewpoint of being capable of lithiation with the optical purity of the phosphinobenzene derivative represented by the general formula (3A) being held, preferably −80° C. to 20° C., and especially preferably −80° C. to 0° C. The reaction time of the lithiation is usually 0.5 to 10 hours, and preferably 1 to 8 hours.

In the lithiation (ii), although by adding the lithiating agent is added to a liquid containing the phosphinobenzene derivative represented by the general formula (3A), the lithiation of the phosphinobenzene derivative represented by the general formula (3A) is quickly carried out, as required, in order to complete the lithiation reaction, maturation may be carried out following the finish of the addition of the lithiating agent.

In the reaction (iii), according to the following reaction formula (3), the reaction product (3B) obtained by the lithiation (ii) and an alkyldihalogenophosphine represented by the general formula (4) are allowed to react to thereby obtain a reaction product represented by the general formula (3C) in the reaction formula (3). In the reaction step (B1), the reaction (iii) can be carried out continuously from the lithiation (ii).

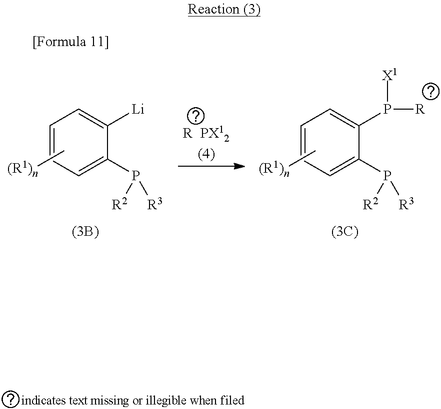

wherein R¹, R², R³, X¹ and n have the same meanings as defined above; and R^{a} is one of R⁴ and R⁵ in the general formula (6).

R^{a} in the general formula (4) is preferably a group having a larger number of carbon atoms out of R⁴ and R⁵. A halogen atom represented by X¹ includes fluorine, chlorine, bromine and iodine, and chlorine is preferable. The alkyldihalogenophosphine represented by the general formula (4) is available as a commercially available product. The alkyldihalogenophosphine represented by the general formula (4) can also be produced industrially and inexpensively (for example, see Japanese Patent Laid-Open Nos. 2002-255983 and 2001-354683).

Examples of the solvent to be used in the reaction (iii) include THF, hexane, toluene, 1,2-dimethoxyethane, tetrahydrofuran, diethyl ether, cyclopentyl methyl ether and dioxane. These may be used singly or as a mixture of two or more.

In the reaction (iii), the amount of the alkyldihalogenophosphine represented by the general formula (4) to be used is, with respect to 1 mol of the phosphinobenzene borane derivative represented by the general formula (3) used in the deboranation (i), preferably 1.0 to 2.0 mol, and especially preferably 1.1 to 1.5 mol. The reaction time of the reaction (iii) is preferably 0.5 to 24 hours, and especially preferably 1 to 12 hours. The reaction temperature of the reaction (iii) is preferably −80° C. to 80° C., and especially preferably −80° C. to 20° C.

In the reaction (iv), according to the following reaction formula (4), the reaction product (3C) obtained by the reaction (iii) and a Grignard regent represented by the general formula (5) are allowed to react to thereby obtain a 1,2-bis(dialkylphosphino)benzene derivative represented by the general formula (6) in the reaction formula (4). In the reaction step (B1), the reaction (iv) can be carried out continuously from the reaction (iii).

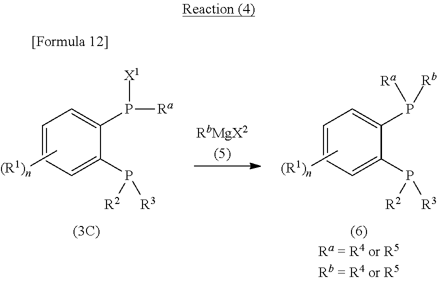

wherein R¹, R², R³, X¹, X² and n have the same meanings as defined above; and R^{a} and R^{b} are the other of R⁴ and R⁵ in the general formula (6).

In the reaction (iv), the reaction can be carried out according to the conventionally known Grignard reaction. For example, in the reaction (iv), the reaction can be carried out in an organic solvent such as THF, hexane, toluene, 1,2-dimethoxyethane, tetrahydrofuran, diethyl ether, cyclopentyl methyl ether or dioxane. In the reaction (iv), the amount of the Grignard regent represented by the general formula (5) to be used is, with respect to 1 mol of the phosphinobenzene borane derivative represented by the general formula (3) used in the deboranation (i), preferably 1.0 to 3.0 mol, and especially preferably 1.0 to 2.0 mol. In the reaction (iv), the reaction time is preferably 0.5 to 24 hours, and especially preferably 1 to 12 hours. In the reaction (iv), the reaction temperature is preferably −80° C. to 80° C., and especially preferably −20° C. to 80° C.

In the reaction step (B1), there may be carried out in the presence of catalysts, the deboranation (i), the lithiation (ii), the reaction (iii) of the reaction product after the deboranation and the lithiation with the alkyldihalogenophosphine, and the reaction (iv) of the reaction product obtained by the reaction (iii) with the Grignard regent. Examples of the catalysts include CuCl, CuCl₂, CuBr, CuBr₂ and Cu(OTf), and it is preferable to use 0.01 to 0.3 mol of a catalyst with respect to 1 mol of (3B).

In the reaction step (B1), it is preferable that there are carried out in an inert gas atmosphere, the deboranation (i), the lithiation (ii), the reaction (iii) of the reaction product after the deboranation and the lithiation with the alkyldihalogenophosphine, and the reaction (iv) of the reaction product obtained by the reaction (iii) with the Grignard regent.

The method for producing a 1,2-bis(dialkylphosphino)benzene derivative relevant to the production method B2 according to the present invention comprises a reaction step (A) of adding liquid B containing a phosphine borane compound obtained by deprotonating a hydrogen-phosphine borane compound represented by the general formula (2) to liquid A containing a 1,2-dihalogenobenzene represented by the general formula (1) to be allowed to react to thereby obtain a phosphinobenzene borane derivative represented by the general formula (3), and a reaction step (B2) of deboranating the phosphinobenzene borane derivative represented by the general formula (3), then lithiating the resultant, and then reacting the resultant with a dialkylhalogenophosphine represented by the general formula (4′) to thereby obtain the 1,2-bis(dialkylphosphino)benzene derivative represented by the general formula (6).

The reaction step (A) relevant to the production method B2 of the 1,2-bis(dialkylphosphino)benzene derivative according to the present invention is the same as the reaction step (A) relevant to the method for producing a phosphinobenzene borane derivative according to the present invention.

The reaction step (B2) comprises deboranation (i), lithiation (ii), and a reaction (v) of a reaction product after the deboranation and the lithiation with a dialkylhalogenophosphine.

Then, in the reaction step (B2), the deboranation (i) and the lithiation (ii) are the same in the reaction step (B1).

In the reaction (v), according to the following reaction formula (5), a reaction product (3B) obtained by the lithiation (ii) and a dialkylhalogenophosphine represented by the general formula (4′) are allowed to react to thereby obtain a 1,2-bis(dialkylphosphino)benzene derivative represented by the general formula (6) in the reaction formula (5). In the reaction step (B2), the reaction (v) can be carried out continuously from the lithiation (ii).

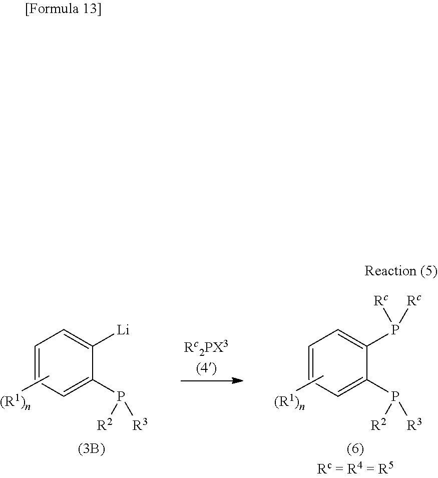

wherein R¹, R², R³, X³ and n have the same meanings as defined above; and R is equivalent to R⁴ and R⁵ in the case of being the same in the general formula (6).

Examples of a solvent to be used in the reaction (v) include THF, hexane, toluene, 1,2-dimethoxyethane, tetrahydrofuran, diethyl ether, cyclopentyl methyl ether and dioxane, and these may be used singly or as a mixture of two or more.

In the reaction (v), the amount of the dialkylhalogenophosphine represented by the general formula (4′) to be used is, with respect to 1 mol of the phosphinobenzene borane derivative represented by the general formula (3) used in the deboranation (i), preferably 1.0 to 2.0 mol, and especially preferably 1.1 to 1.5 mol. The reaction time of the reaction (v) is preferably 0.5 to 24 hours, and especially preferably 1.0 to 12 hours. The reaction temperature of the reaction (v) is preferably −80° C. to 80° C., and especially preferably −20° C. to 80° C.

In the reaction step (B2), it is preferable that there are carried out in an inert gas atmosphere, the deboranation (i), the lithiation (ii), and the reaction (v) of the reaction product after the deboranation and the lithiation with the dialkylhalogenophosphine.

In the reaction step (B2), there may be carried out in the presence of catalysts, the deboranation (i), the lithiation (ii), and the reaction (v) of the reaction product after the deboranation and the lithiation with the dialkylhalogenophosphine. Examples of the catalysts include CuCl, CuCl₂, CuBr, CuBr₂ and Cu(OTf), and it is preferable to use 0.01 to 0.3 mol of a catalyst with respect to 1 mol of (3B).

The method for producing a 1,2-bis(dialkylphosphino)benzene derivative relevant to the production method B3 according to the present invention comprises a reaction step (A) of adding liquid B containing a phosphine borane compound obtained by deprotonating a hydrogen-phosphine borane compound represented by the general formula (2) to liquid A containing a 1,2-dihalogenobenzene represented by the general formula (1) to be allowed to react to thereby obtain a phosphinobenzene borane derivative represented by the general formula (3), and a reaction step (B3) of lithiating the phosphinobenzene borane derivative represented by the general formula (3), then reacting the resultant with a dialkylhalogenophosphine represented by the general formula (4′), and then deboranating the resultant to thereby obtain the 1,2-bis(dialkylphosphino)benzene derivative represented by the general formula (6).

The reaction step (A) relevant to the production method B3 of the 1,2-bis(dialkylphosphino)benzene derivative according to the present invention is the same as the reaction step (A) relevant to the method for producing a phosphinobenzene borane derivative according to the present invention.

The reaction step (B3) comprises lithiation (vi), a reaction (vii) of a reaction product after the lithiation with a dialkylhalogenophosphine, and deboranation (viii).

In the lithiation (vi), according to the following reaction formula (6), the lithiation of the phosphinobenzene borane derivative represented by the general formula (3) is carried out in a solvent by a lithiating agent to thereby obtain a reaction product represented by the general formula (3a) in the reaction formula (6).

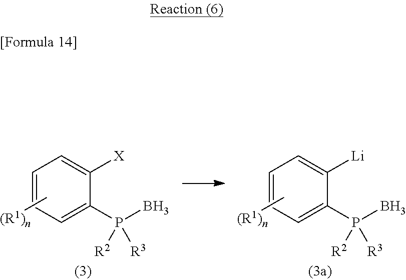

wherein R¹, R², R³, X and n have the same meanings as defined above.

As the lithiating agent and the solvent to be used in the lithiation (vi), the same lithiating agent and solvent as in the above lithiation (ii) can be used. The amount of the lithiating agent to be added is, in molar ratio of the lithiating agent with respect to the phosphinobenzene borane derivative represented by the general formula (3), from the viewpoint of the economic efficiency and the reactivity, preferably 1.0 to 1.5, and from the viewpoint of suppressing side reactions, more preferably 1.0 to 1.2. In the lithiation (vi), the addition temperature when the lithiating agent is added, that is, the temperature of the reaction liquid when the lithiating agent is added is, from the viewpoint of being capable of lithiation with the optical purity of the phosphinobenzene borane derivative represented by the general formula (3) being held, −80 to 20° C., and especially preferably −80 to 0° C. The reaction time of the lithiation is usually 3 min to 10 hours, and preferably 3 min to 8 hours.

In the lithiation (vi), although by adding the lithiating agent is added to a liquid containing the phosphinobenzene borane derivative represented by the general formula (3), the lithiation of the phosphinobenzene borane derivative represented by the general formula (3) is quickly carried out, as required, in order to complete the lithiation reaction, maturation may be carried out following the finish of the addition of the lithiating agent.

In the reaction (vii), according to the following reaction formula (7), the reaction product (3a) obtained by the lithiation (vi) and a dialkylhalogenophosphine represented by the general formula (4′) are allowed to react to thereby obtain a reaction product represented by the general formula (3b) in the following reaction formula (7). In the reaction step (B3), the reaction (vii) can be carried out continuously from the lithiation (vi).

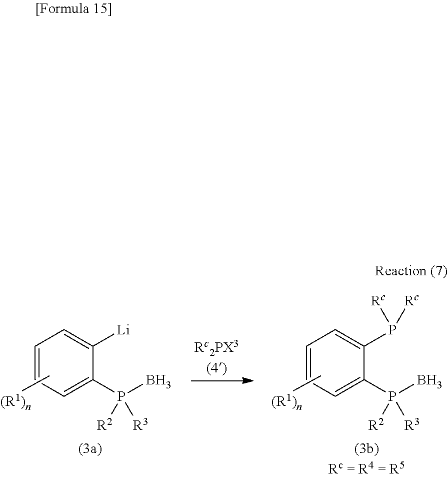

wherein R¹, R², R³, X³ and n have the same meanings as defined above; and R^{c} is equivalent to R⁴ and R⁵ in the case of being the same in the general formula (6).

As a solvent to be used in the reaction with a dialkylhalogenophosphine represented by the general formula (4) in the reaction (vii), the same one as in the above reaction (v) is used.

In the reaction (vii), the amount of the dialkylhalogenophosphine represented by the general formula (4′) to be used is, with respect to 1 mol of the phosphinobenzene borane derivative represented by the general formula (3) used in the lithiation (vi), preferably 1.0 to 2.0 mol, and especially preferably 1.1 to 1.5 mol. The reaction time of the reaction (vii) is preferably 0.5 to 24 hours, and especially preferably 1.0 to 12 hours. The reaction temperature of the reaction (vii) is preferably −80° C. to 80° C., and especially preferably −20° C. to 80° C.

In the deboranation (viii), according to the following reaction formula (8), a deboranation reaction of the reaction product represented by the general formula (3b) is carried out in a solvent by a deboranating agent to thereby obtain a 1,2-bis(dialkylphosphino)benzene derivative represented by the general formula (6) in the following reaction formula (8). In the reaction step (B3), the deboranation (viii) can be carried out continuously from the reaction (vii).

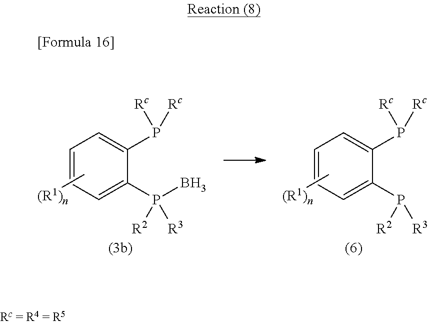

wherein R¹, R², R³ and n have the same meanings as defined above; and R^{c} is equivalent to R⁴ and R in the case of being the same in the general formula (6).

As the solvent and the deboranating agent to be used in the deboranation (viii), the same solvent and deboranating agent as in the deboranation (i) can be used.

The reaction temperature of the deboranation reaction in the deboranation (viii) is, from the viewpoint of obtaining a 1,2-bis(dialkylphosphino)benzene derivative represented by the general formula (6) high in optical purity, preferably 20 to 120° C., and more preferably 30 to 80° C. The reaction time of the deboranation reaction in the deboranation (viii) is preferably 10 min or longer, especially preferably 0.5 to 10 hours, and more preferably 1 to 8 hours.

In the reaction step (B3), it is preferable that there are carried out in an inert gas atmosphere, the lithiation (vi), the reaction (vii) of the reaction product after the lithiation with the dialkylhalogenophosphine, and the deboranation (viii).

In the reaction step (B3), there may be carried out in the presence of catalysts, the lithiation (vi), the reaction (vii) of the reaction product after the lithiation with the dialkylhalogenophosphine, and the deboranation (viii). Examples of the catalysts include CuCl, CuCl₂, CuBr, CuBr₂ and Cu(OTf), and it is preferable to use 0.01 to 0.3 mol of a catalyst with respect to 1 mol of (3a).

Then, by carrying out the production method B1 according to the present invention, the production method B2 according to the present invention or the production method B3 according to the present invention, the objective substance, the 1,2-bis(dialkylphosphino)benzene derivative represented by the general formula (6) is obtained. When the objective substance, the benzene derivative obtained by carrying out the production method B1 according to the present invention is an optically active substance, the objective substance is an (R,R) isomer or an (S,S) isomer, but there are some cases where a mixture containing an (R,S) isomer or an (S,R) isomer, for example, a meso form is obtained as products other than the objective substance. In such cases, if necessary, by carrying out refinement (a), the objective substance can be obtained in a high purity by separation of the (R,R) isomer or the (S,S) isomer being the objective substance of the present invention from the mixture containing the objective substance and the products other than the objective product. Also when the benzene derivative being the objective substance obtained by carrying out the production method B2 according to the present invention is an optically active substance, if necessary, by carrying out refinement (a), the objective substance according to the present invention can be obtained in a high purity from a mixture containing the objective substance and products other than the objective substance. The separation of the objective substance according to the present invention suffices if being carried out by a usual refinement method, and usually, recrystallization suffices. The separation of the objective substance according to the present invention, as required, can be carried out by column separation. When the refinement (a) is carried out, it is preferable that refinement (a′) is previously carried out by a refinement method such as solvent removal or washing. When the refinement is carried out by column separation or the like, if necessary, in order to stabilize the compound, the 1,2-bis(dialkylphosphino)benzene derivative represented by the general formula (6) may be boranated with a borane-THF solution in an equivalent weight or more with respect to the 1,2-bis(dialkylphosphino)benzene derivative represented by the general formula (6), and column separated and thereafter deboranated as in the deboranation (i) or the deboranation (viii) to thereby obtain the 1,2-bis(dialkylphosphino)benzene derivative represented by the general formula (6) being the objective substance.

An embodiment according to the present invention includes an (R)-1-dialkylphosphino-2-diphenylphosphinobenzene represented by the following general formula (7):

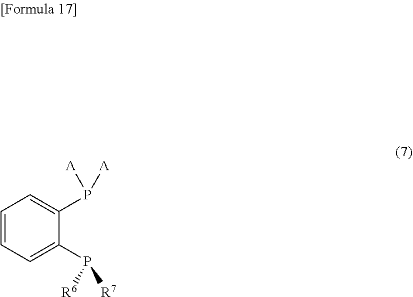

wherein R⁶ and R⁷ each denote a straight-chain or branched-chain alkyl group having 1 to 10 carbon atoms which may be substituted, or a cycloalkyl group which may be substituted, provided R⁶ and R⁷ are not the same group; and A denotes a phenyl group which may be substituted.

Further an embodiment according to the present invention includes (R)-1-tert-butylmethylphosphino-2-diphenylphosphinobenzene represented by the following general formula (8):

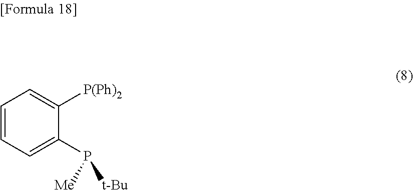

Further an embodiment according to the present invention includes an (R)-dialkylphosphino-2-bis(pentafluorophenyl)phosphinobenzene represented by the following general formula (9):

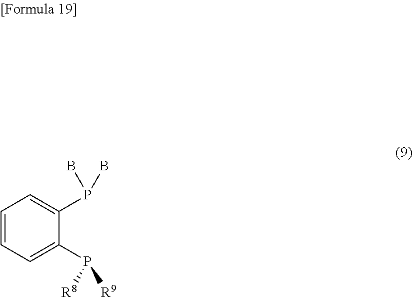

wherein R⁸ and R⁹ each denote a straight-chain or branched-chain alkyl group having 1 to 10 carbon atoms which may be substituted, or a cycloalkyl group which may be substituted, provided R⁸ and R⁹ are not the same group; and B denotes a pentafluorophenyl group which may be substituted.

Further an embodiment according to the present invention includes (R)-1-tert-butylmethylphosphino-2-bis(pentafluorophenyl)phosphinobenzene represented by the following general formula (10):

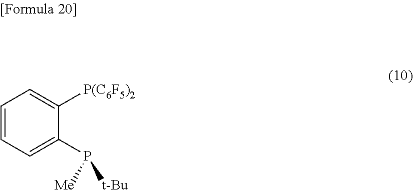

The 1,2-bis(dialkylphosphino)benzene derivative represented by the general formula (6) obtained by the method for producing a 1,2-bi(dialkylphosphino)benzene derivative according to the present invention can form, as a ligand, a complex with a transition metal. That is, the 1,2-bis(dialkylphosphino)benzene derivative represented by the general formula (6) obtained by the method for producing a 1,2-bis(dialkylphosphino)benzene derivative according to the present invention, for example, the (R)-1-dialkylphosphino-2-diphenylphosphinobenzene represented by the above general formula (7) according to the present invention, the (R)-1-tert-butylmethylphosphino-2-diphenylphosphinobenzene represented by the above general formula (8) according to the present invention, the (R)-dialkylphosphino-2-bis(pentafluorophenyl)phosphinobenzene represented by the above general formula (9) according to the present invention, and the (R)-1-tert-butylmethylphosphino-2-bis(pentafluorophenyl)phosphinobenzene represented by the above general formula (10) according to the present invention are used suitably as a ligand to form a complex with a transition metal.

In the general formula (7), when A is a phenyl group having a substituent, the substituent includes alkyl groups, alkoxy groups, a nitro group, an amino group, a hydroxyl group, a fluoro group, a chloro group, a bromo group and an iodo group. In the general formula (9), when B is a pentafluorophenyl group having a substituent, the substituent includes alkyl groups, alkoxy groups, a nitro group, an amino group, a hydroxyl group, a fluoro group, a chloro group, a bromo group and an iodo group. In the general formulae (7) and (9), examples of the alkyl groups represented by R⁶ to R⁹ include a methyl group, an ethyl group, an isopropyl group, an n-propyl group, an isobutyl group, an n-butyl group, a sec-butyl group, a tert-butyl group, an isoheptyl group, an n-heptyl group, an isohexyl group and an n-hexyl group. The cycloalkyl groups represented by R⁶ to R⁹ include a cyclopentyl group and a cyclohexyl group. When R⁶ to R⁹ are cycloalkyl groups having a substituent, the substituent includes alkyl groups, alkoxy groups, a nitro group, an amino group, a hydroxyl group, a fluoro group, a chloro group, a bromo group and an iodo group. When R⁶ to R⁹ are alkyl groups having a substituent, the substituent includes a phenyl group, alkoxy groups, a nitro group, an amino group, a hydroxyl group, a fluoro group, a chloro group, a bromo group and an iodo group.

That is, the transition metal complex according to the present invention is a transition metal complex comprising a transition metal, and the 1,2-bis(dialkylphosphino)benzene derivative represented by the general formula (6), which coordinates to the transition metal, obtained by the method for producing a 1,2-bis(dialkylphosphino)benzene derivative according to the present invention, for example, the (R)-1-dialkylphosphino-2-diphenylphosphinobenzene represented by the above general formula (7) according to the present invention, the (R)-1-tert-butylmethylphosphino-2-diphenylphosphinobenzene represented by the above general formula (8) according to the present invention, the (R)-dialkylphosphino-2-bis(pentafluorophenyl)phosphinobenzene represented by the above general formula (9) according to the present invention, or the (R)-1-tert-butylmethylphosphino-2-bis(pentafluorophenyl)phosphinobenzene represented by the above general formula (10) according to the present invention.

Examples of the transition metal capable of forming the complex in the transition metal complex according to the present invention include rhodium, ruthenium, iridium, palladium, nickel, iron and copper, and preferable are rhodium and palladium metals. A method for forming a complex with rhodium metal by using, a ligand, an optically active 1,2-bis(dialkylphosphino)benzene derivative represented by the general formula (6) may be, for example, a method described in Experimental Chemistry Guide Book, 4th edition (edited by The Chemical Society of Japan, published by Maruzen Bookstores Co., vol. 18, pp. 327-353); a rhodium complex can be produced, for example, by reacting the optically active 1,2-bis(dialkylphosphino)benzene derivative represented by the general formula (6) with a bis(cyclooctane-1,5-diene)rhodium hexafluoroantimonic acid salt, a bis(cyclooctane-1,5-diene)rhodium tetrafluoroboric acid salt or the like.

Specific examples of the obtained rhodium complex include [Rh((S,S)-(A)) (cod)]Cl, [Rh((S,S)-(A)) (cod)]Br, [Rh((S,S)-(A)) (cod)]I, [Rh((R,R)-(A))(cod)]Cl, [Rh((R,R)-(A)) (cod)]Br, [Rh((R,R)-(A))(cod)]I, [Rh((S,S)-(A)) (cod)]SbF₆, [Rh((S,S)-(A)) (cod)]BF₄, [Rh((S,S)-(A)) (cod)]ClO₄, [Rh((S,S)-(A)) (cod)]PF₆, [Rh((S,S)-(A)) (cod)]BPh₄, [Rh((R,R)-(A)) (cod)]SbF₆, [Rh((R,R)-(A)) (cod)]BF₄, [Rh((R,R)-(A)) (cod)]ClO₄, [Rh((R,R)-(A)) (cod)]PF₆, [Rh((R,R)-(A)) (cod)]BPh₄, [Rh((S,S)-(A)) (nbd)]SbF₆, [Rh((S,S)-(A)) (nbd)]BF₄, [Rh((S,S)-(A)) (nbd)]ClO₄, [Rh((S,S)-(A)) (nbd)]PF₆, [Rh((S,S)-(A)) (nbd)]BPh₄, [Rh((R,R)-(A)) (nbd)]SbF₆, [Rh((R,R)-(A)) (nbd)]BF₄, [Rh((R,R)-(A)) (nbd)]ClO₄, [Rh((R,R)-(A)) (nbd)]PF₆ and [Rh((R,R)-(A)) (nbd)]BPh₄; and in the present invention, [Rh((S,S)-(A)) (cod)]SbF₆ or [Rh((R,R)-(A))(cod)]SbF₆ is preferable. Here, (A) in the rhodium complex denotes the 1,2-bis(dialkylphosphino)benzene derivative represented by the general formula (6), for example, the (R)-1-dialkylphosphino-2-diphenylphosphinobenzene represented by the above general formula (7) according to the present invention, the (R)-1-tert-butylmethylphosphino-2-diphenylphosphinobenzene represented by the above general formula (8) according to the present invention, the (R)-dialkylphosphino-2-bis(pentafluorophenyl)phosphinobenzene represented by the above general formula (9) according to the present invention, or the (R)-1-tert-butylmethylphosphino-2-bis(pentafluorophenyl)phosphinobenzene represented by the above general formula (10) according to the present invention; cod denotes 1,5-cyclooctadiene; nbd denotes norbornadiene; and Ph denotes phenyl.

A transition metal complex having, as a ligand, an optically active substance of the 1,2-bis(dialkylphosphino)benzene derivative represented by the general formula (6), (that is, referred to also as the transition metal complex according to the present invention) is useful as an asymmetric synthesis catalyst. Examples of the asymmetric synthesis include asymmetric hydrogenation reaction, asymmetric hydrosilylation reaction, asymmetric Michael addition reaction, asymmetric 1,4-addition reaction to an electron-deficient olefin using an organoboronic acid, and asymmetric cyclization. These asymmetric synthesis reactions can be carried out as usual, except for using the transition metal complex according to the present invention.

The transition metal complex according to the present invention is suitable particularly as a catalyst in the asymmetric hydrogenation reaction. Examples of a compound to be used as a substrate in the asymmetric hydrogenation reaction include compounds having a C═C double bond or a C═O double bond containing a prochiral carbon atom, and examples thereof include α-dehydroamino acids, β-dehydroamino acids, itaconic acid, enamides, β-keto esters, enol esters, α,β-unsaturated carboxylic acids and β,γ-unsaturated carboxylic acids. In the asymmetric hydrogenation reaction, it is preferable that the molar ratio (substrate/catalyst) of a substrate to the transition metal complex according to the present invention being a catalyst is unlimitedly high, but it is preferable that the molar ratio is practically usually 100 to 100,000.

### EXAMPLES

Hereinafter, the present invention will be described in detail by way of Examples, but the present invention is not any more limited to these Examples.

### Synthesis of (S)-tert-butylmethylphosphine-borane

Benzoyl chloride (2.1 mL, 18 mmol) was dropwise charged at 0° C. under stirring in a solution in which (S)-tert-butyl(hydroxymethyl)methylphosphine-borane (92% ee, 2.22 g, 15.0 mmol) was dissolved in 10 ml of pyridine. Then, the liquid reaction mixture was heated to room temperature. After an elapse of 1 hour, the liquid reaction mixture was diluted with water, and extracted three times with ether. An obtained organic layer was washed with IM hydrochloric acid, a sodium hydrogencarbonate aqueous solution and saturated brine, and dehydrated with sodium sulfate. After the solvent was removed, the resultant residue was refined by silica gel column chromatography (mobile phase: hexane/ethyl acetate=3/1). A colorless solid was obtained, and the solid was recrystallized two times in a hexane/ethyl acetate mixed solvent. An optically pure benzoyloxymethyl(tert-butyl)methylphosphine-borane was thus obtained. The yield amount was 2.34 g and the yield was 62%.

Then, potassium hydroxide (4.0 g, 72 mmol) dissolved in 15 ml of water was dropwise charged in a solution in which the benzoyloxymethyl(tert-butyl)methylphosphine-borane (99% ee, 6.05 g, 24.0 mmol) was dissolved in 25 ml of ethanol. Hydrolysis was completed in about 1 hour. The liquid reaction mixture was diluted with water, and extracted three times with ether. The extract was washed with saturated brine, and dehydrated with sodium sulfate. The solvent was removed by a rotary evaporator, and the resultant residue was refined by silica gel column chromatography (mobile phase: hexane/ethyl acetate=3/1) to thereby obtain (S)-tert-butyl(hydroxymethyl)methylphosphine-borane. This compound was dissolved in 72 ml of acetone. The resultant acetone solution was little by little added to an aqueous solution (0° C.) in which potassium hydroxide (13.5 g, 240 mmol), potassium persulfate (19.4 g, 72.0 mmol) and ruthenium trichloride trihydrate (624 mg, 2.4 mmol) were dissolved in 150 ml of water in the state that the aqueous solution was vigorously stirred. After an elapse of 2 hours, the liquid reaction mixture was neutralized with 3M hydrochloric acid, and extracted three times with ether. The extract was washed with saturated brine, and dehydrated with sodium sulfate. The solvent was removed at room temperature by a rotary evaporator, and the resultant reside was refined by silica gel column chromatography (mobile phase: pentane/ether=8/1). (S)-tert-butylmethylphosphine-borane (purity: 98.5% ee) was thus obtained. The yield amount was 2.27 g and the yield was 80%.

### Example 1

### Synthesis of (R)-2-(boranato)(t-butyl)methylphosphino-1-bromobenzene (a3)

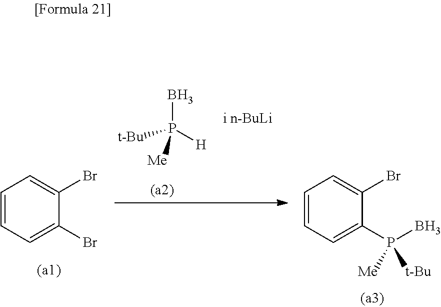

The (S)-tert-butylmethylphosphine-borane (354 mg, 3 mmol) and a magnetic stirrer bar were put in a well-dried 10-mL two-necked flask, and the system interior was replaced by argon. After THF (3 mL) was added, the flask was dipped in a refrigerant bath of −80° C., and n-BuLi (2.1 mL of 1.55M hexane solution, 3.3 mmol) was slowly added to be caused to generate a phosphide anion; and the resultant was used as liquid B.

On the other hand, 1,2-dibromobenzene (0.53 mL, 4.5 mmol) and THF (1.5 mL) were put in an argon-replaced 30-mL two-necked flask, and cooled to −80° C.; and the resultant was used as liquid A.

The two flasks were coupled by a cannula, and the liquid B was dropwise charged in the liquid A over 15 min at −80° C. maintained.

After the dropping, the bath temperature was raised to 0° C. over about 1 hour. Water and ethyl acetate were added to the reaction mixture and fully stirred; and thereafter, an organic layer was separated and a water layer was extracted with ethyl acetate. The organic layer was joined to the extract and washed with water, and dried by anhydrous sodium sulfate. After the solvent was removed by using an evaporator and a vacuum pump, the flask was dipped in ice water, and 1 mL of hexane was added and well stirred. A solid substance was filtered off, and washed with a small amount of cold hexane to thereby obtain a white crystal (yield amount: 582 mg, yield: 71%).

After the filtrate was concentrated, the resultant was refined by column chromatography (eluate: ethyl acetate/hexane=1:15) to thereby obtain 104 mg (13%) of a second crop. The yield amount of the first crop and the second crop put together was 686 mg, and the yield thereof was 84%. The purity as determined by ³¹P NMR was 99.0%, and the optical purity was 99.0% ee or higher.

(Identification Data of the Compound (a3))
(mp 90-92° C., TLC: silica gel Rf=0.40 (hexane/AcOEt=10:1).
¹H NMR (CDCl₃) δ 0.54-0.92 (br m, 3H), 1.20 (d, J=14.4 Hz, 9H), 1.91 (d, J=10.0 Hz, 3H), 7.32 (t, J=7.7 Hz, 1H), 7.40 (t, J=8.0 Hz, 1H), 7.64 (d, 7.6 Hz, 1H), 8.06 (dd, J=7.7, 12.9 Hz, 1H);

### ¹³C NMR (CDCl3) δ 8.83 (d, J=37.2 Hz), 26.09 (d, J=2.4 Hz), 31.26 (d, J=31.2 Hz), 127.02 (d, J=12.0 Hz), 127.27 (s), 128.47 (d, J=45.6 Hz), 132.63 (s), 135.23 (d, J=4.8 Hz), 139.24 (d, J=16.8 Hz);

### ³¹P NMR (CDCl3) δ 38.6 (s).

HRMS (TOF): Calcd for C₁₁H₁₉BBrNaP: 297.0378; Found: 297.0038.

HPLC: Daicel Chiralcel ADH (hexane: i-PrOH=99.5:0.5, 0.5 mL/min, 254 nm); (S) t1=13.2 min, (R) t2=14.2 min.)

### Example 2

### Synthesis of (R)-2-(boranato)(t-butyl)methylphosphino-1-bromobenzene (a3)

(R)-2-(boranato)(t-butyl)methylphosphino-1-bromobenzene (a3) was obtained by the same operation as in Example 1, except for dropwise charging the liquid B to the liquid A at −10° C. maintained. The yield of the first crop and the second crop put together was 70%. The purity as determined by ³¹P NMR was 99.2%, and the optical purity was 99.0% ee or higher.

### Example 3

### Synthesis of (R)-2-(boranato)(t-butyl)methylphosphino-1-bromobenzene (a3)

(R)-2-(boranato)(t-butyl)methylphosphino-1-bromobenzene (a3) was obtained by dropwise charging liquid B to liquid A at −80° C. maintained and conducting the same operation as in Example 1, except for using the (S)-t-butylmethylphosphine-borane (354 mg, 3 mmol) and 1,2-dibromobenzene (0.42 mL, 3.6 mmol)(equivalent weight ratio: 1.2). The yield of the first crop was 73% and the yield of the second crop was 9%. The purity as determined by ³¹P NMR was 99.0%, and the optical purity was 99.0% ee or higher.

### Example 4

### Synthesis of (R)-2-(boranato)(t-butyl)methylphosphino-1-bromobenzene (a3)

(R)-2-(boranato)(t-butyl)methylphosphino-1-bromobenzene (a3) was obtained by dropwise charging liquid B to liquid A at −80° C. maintained and conducting the same operation as in Example 1, except for using the (S)-t-butylmethylphosphine-borane (354 mg, 3 mmol) and 1,2-dibromobenzene (0.71 mL, 6.0 mmol)(equivalent weight ratio: 2.0). The yield of the first crop was 58% and the yield of the second crop was 23%. The purity as determined by ³¹P NMR was 98.6%, and the optical purity was 99.0% ee or higher.

### Example 5

### Synthesis of (R)-2-(boranato)(t-butyl)methylphosphino-1-bromobenzene (a3)

(R)-2-(boranato)(t-butyl)methylphosphino-1-bromobenzene (a3) was obtained by dropwise charging liquid B to liquid A at −10° C. maintained and conducting the same operation as in Example 1, except for and using the (S)-t-butylmethylphosphine-borane (354 mg, 3 mmol) and 1,2-dibromobenzene (0.42 mL, 3.6 mmol)(equivalent weight ratio: 1.2). The yield of the first crop was 58% and the yield of the second crop was 14%. The purity as determined by ³¹P NMR was 99.3%, and the optical purity was 99.0% ee or higher.

### Comparative Example 1

### Synthesis of (R)-2-(boranato)(t-butyl)methylphosphino-1-bromobenzene (a3)

(R)-2-(boranato)(t-butyl)methylphosphino-1-bromobenzene (a3) was obtained by the same operation as in Example 1, except for dropwise charging the liquid A to the liquid B. The yield of the first crop and the second crop put together was 65%. The purity as determined by ³¹P NMR was 98.7%, and the optical purity was 99.0% ee or higher.

### Comparative Example 2

### Synthesis of (R)-2-(boranato)(t-butyl)methylphosphino-1-bromobenzene (a3)

(R)-2-(boranato)(t-butyl)methylphosphino-1-bromobenzene (a3) was obtained by the same operation as in Example 2, except for dropwise charging the liquid A to the liquid B. Since no crystal deposited by the same recrystallization operation as in Example 2, an objective substance was obtained by subjecting the whole amount of a crude product after the post-treatments to the column treatment. The yield was 24%. The purity as determined by ³¹P NMR was 99.1%, and the optical purity was 99.0% ee or higher.

TABLE 1

| | Addition manner | Addition temperature | | | Optical |
|---|---|---|---|---|---|
| | of the liquid A | of the liquid A or the | Yield | Purity | purity |
| | and the liquid B | liquid B (° C.) | (%) | (%) | (% ee) |
| Example 1 | adding the liquid | −80 | 84 | 99.0 | ≥99.0 |
| | B to the liquid A | | | | |
| Example 2 | adding the liquid | −10 | 70 | 99.2 | ≥99.0 |
| | B to the liquid A | | | | |
| Example 3 | adding the liquid | −80 | 82 | 99.0 | ≥99.0 |
| | B to the liquid A | | | | |
| Example 4 | adding the liquid | −80 | 81 | 98.6 | ≥99.0 |
| | B to the liquid A | | | | |
| Example 5 | adding the liquid | −10 | 72 | 99.3 | ≥99.0 |
| | B to the liquid A | | | | |
| Comparative | adding the liquid | −80 | 65 | 98.7 | ≥99.0 |
| Example 1 | A to the liquid B | | | | |
| Comparative | adding the liquid | −10 | 24 | 99.1 | ≥99.0 |
| Example 2 | A to the liquid B | | | | |

### Example 6

### Synthesis of (R,R)-1,2-bis(tert-butylmethylphosphino)benzene (a6)

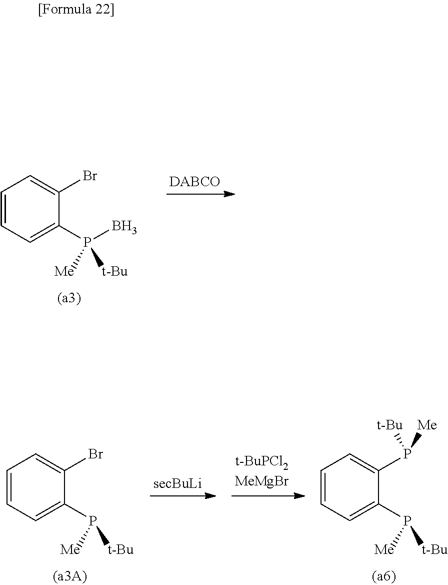

1.365 g (5.00 mmol) of (R)-2-(boranato)(t-butyl)methylphosphino-1-bromobenzene (a3) obtained in the procedure of Example 1 and 589 mg (5.25 mmol) of 1,4-diazabicyclo[2.2.2]octane (DABCO) were charged in a well-dried 50-mL two-necked flask, and after the flask interior was replaced by Ar, 10 mL of dehydrated tetrahydrofuran was added and stirred for dissolution. This solution was allowed to react under mild reflux at about 70° C. for 2 hours. Thereafter, the resultant was cooled to −78° C., and 5.10 mL of a hexane solution of sec-butylithium (1.03 mmol/L) was slowly added by a syringe. After 30 min, 3 ml of a THF solution of 875 mg (5.5 mmol) of tert-butyldichlorophosphine was added at a stretch. Then, the resultant was heated to room temperature (20° C.) over 1 hour, and stirred further for 1 hour. Thereafter, the resultant was cooled to 0° C., and 12.5 ml of a THF solution of methylmagnesium bromide (0.96 mol/L) was added by a syringe; thereafter, the resultant was heated to room temperature, and was stirred further for 1 hour. Then, most of the solvent was concentrated, and 25 ml of degassed hexane and 10 ml of a degassed 15-mas % NH₄Cl aqueous solution were added. After a hexane layer was separated, the resultant was washed with brine, and dried with Na₂SO₄. Thereafter, the solvent was concentrated, and degassed methanol was added to a resultant oily residue. A produced crystal was filtered, and washed with a small amount of cold methanol, and vacuum dried to thereby obtain 539 mg (yield: 38%) of (R,R)-1,2-bis(tert-butylmethylphosphino)benzene. The optical purity was 99.0% ee or higher. The analysis result of the obtained compound is shown below.

(Identification Data of the Compound (a6))
¹H NMR (500 MHz, CDCl₃) δ: 0.96 (t, J=6.0 Hz, 18H), 1.23 (t, J=3.2 Hz, 6H), 7.26-7.35 (m, 2H), 7.48-7.50 (m, 2H)
¹³C NMR (125 MHz, CDCl₃) δ: 5.69 (t, J=6.0 Hz), 27.24 (t, 8.4 Hz), 30.37 (t, 7.2 Hz), 127.75 (S), 131.47 (S), 144.86 (t, 6.0 Hz)
³¹P NMR (202 MHz, CDCl₃) δ: −25.20 (s).

### APCI-MS: m/z 283 (M⁺+H).

HRMS (TOF): Calcd. for C₁₆H₂₈NaP₂: 305.1564, Found: 305.1472 mp. 125-126° C.

[α]_{D}²⁴: +222.9 (c, 0.535, EtOAc)

### Example 7

### Synthesis of (R)-1-tert-butylmethylphosphino-2-diphenylphosphinobenzene

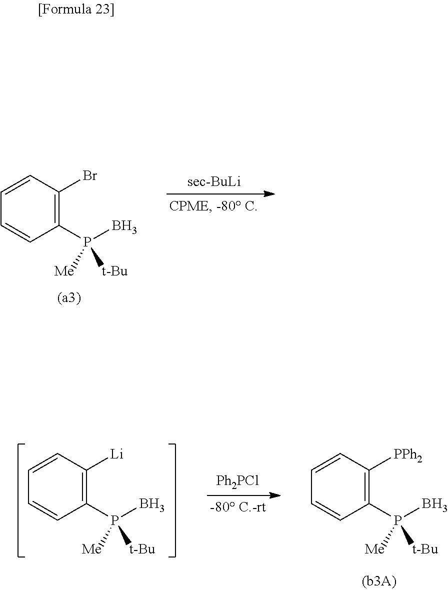

1-(boranato)-tert-butylmethylphosphino-2-bromobenzene (137 mg, 0.5 mmol) obtained by the same procedure described in Example 1 was charged in a 10-mL two-necked flask installed with a three-way cock and a septum; vacuumizing and argon introduction were repeated to replace the system interior by argon. Dehydrated cyclopentyl methyl ether (CPME)(1.5 mL) was added, and thereafter, the flask was dipped in a low-temperature bath of −80° C., and sec-BuLi (0.5 mmol) was dropwise charged over 5 min under stirring by a magnetic stirrer by a syringe. After the dropping, the resultant was held at the temperature for 30 min, and thereafter, chlorodiphenylphophine (110 mL, 0.6 mmol) was added at a stretch by a microsyringe. The reaction temperature was raised to room temperature over about 1 hour, and stirring was continued further for 1 hour. A produced white precipitate was filtered and removed, and the filtrate was concentrated by an evaporator, and thereafter refined by preparative thin layer chromatography to thereby obtain (R)-1-(boranato)-tert-butylmethylphosphino-2-diphenylphosphinobenzene (b3A) as a white crystal. The yield amount was 136 mg, and the yield was 72%.

(Identification Data of the Compound (b3A))

1H NMR (500 MHz, CDCl₃) δ 0.5-1.0 (br q, 3H, BH₃), 1.33 (d, ³J_{HP}=14.4 Hz, 9H, C(CH₃)₃), 1.90 (d, =²J_{HP}=9.8 Hz, 3H, PCH₃), 7.12-7.47 (m, 13H), 8.19-8.25 (m, 1H). ¹³C NMR (125 MHz, CDCl₃) δ 11.6 (dd, J_{CP}=35.7, 28.9 Hz), 26.4, 30.3 (d, J_{CP}=32.2 Hz), 128.6-129.1 (m), 131.0, 132.9-138.3 (m), 142.3 (d, J_{CP}=23.7 Hz). ³¹P NMR (200 MHz, CDCl₃) δ −8.1, 37.0.

### R_{f}=0.47 (AcOEt/hexane=1:10)

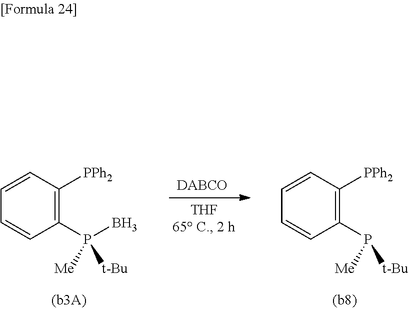

The (R)-1-(boranato)-tert-butylmethylphosphino-2-diphenylphosphinobenzene (b3A)(23 mg, 0.06 mmol) and DABCO (13 mg, 0.12 mmol) were charged in a 10-mL two-necked flask installed with a three-way cock and a septum; vacuumizing and argon introduction were repeated to replace the system interior by argon. Dehydrated THF (0.5 mL) was added, and thereafter, the flask was dipped in an oil bath of 60 to 65° C. to cause the resultant to react for 2 hours. After the finish of the reaction, most of the solvent was removed by a diaphragm, and thereafter, the resultant residue was dried by a vacuum pump to thereby obtain (R)-1-tert-butylmethylphosphino-2-diphenylphosphinobenzene (b6). The yield amount was 19 mg, and the yield was 86%.

(Identification Data of the Compound (b6))
¹H NMR (500 MHz, CDCl₃) δ 1.05 (d, ³J_{HP}=12.0 Hz, 9H, C(CH₃)₃), 1.19 (d, ²J_{HP}=4.6 Hz, 3H, PCH₃), 6.92-6.96 (m, 1H), 7.12-7.17 (m, 2H). 7.21-7.36 (m, 10H), 7.54-7.58 (m, 1H).
¹³C NMR (125 MHz, CDCl₃) δ 6.5, 27.5 (d, ³J_{CP}=13.1 Hz), 30.3 (d, J_{CP}=14.3 Hz), 128.1-145.8 (m).
³¹P NMR (200 MHz, CDCl₃) δ −23.5 (d, J_{PP}=162 Hz), −12.0 (d, J_{PP}=162 Hz).

### R_{f}=0.52 (AcOEt/hexane=1:10)

### Example 8

### Synthesis of (R)-1-tert-butylmethylphosphino-2-bis(pentafluorophenyl)phosphinobenzene

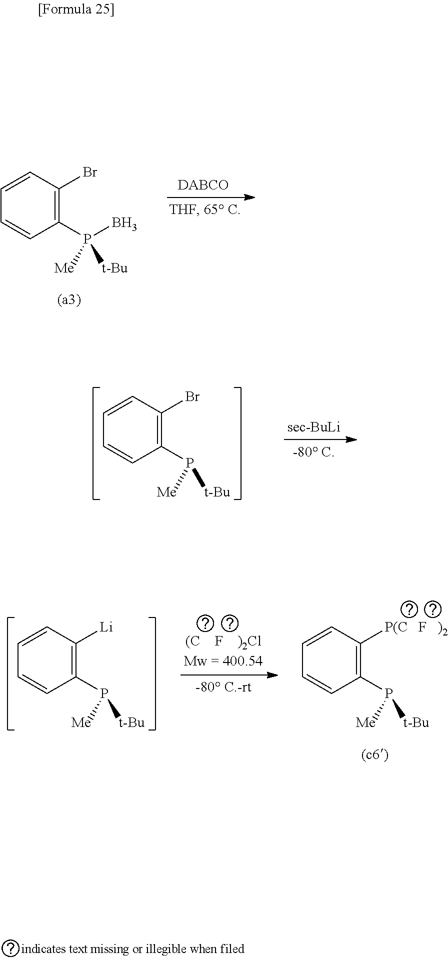

The 1-(boranato)-tert-butylmethylphosphino-2-bromobenzene (819 mg, 3 mmol) and 1,4-diazabicyclo[2.2.2]octane (DABCO)(370 mg, 3.3 mmol) were charged in a 30-mL two-necked flask installed with a three-way cock and a septum; vacuumizing and argon introduction were repeated to replace the system interior by argon. Dehydrated THF (6 mL) was added, and thereafter, the flask was dipped in an oil bath of 65° C. to cause the resultant to be deboranated. After 1.5 hours, the reaction vessel was taken out from the oil bath and dipped in a low-temperature bath of −80° C. Sec-BuLi (3.15 mmol) was dropwise charged over 5 min by a syringe under stirring by a magnetic stirrer. After the dropping, the resultant was held at the temperature for 30 min, and thereafter, a THF (1 mL) solution of chlorobis(pentafluorophenyl)phosphine (1.32 g, 3.3 mmol) was added at a stretch by a syringe. The reaction temperature was raised to 40° C. over about 2 hours and stirring was continued further for 1 hour to thereby obtain a reaction liquid containing a crude compound (c6′).

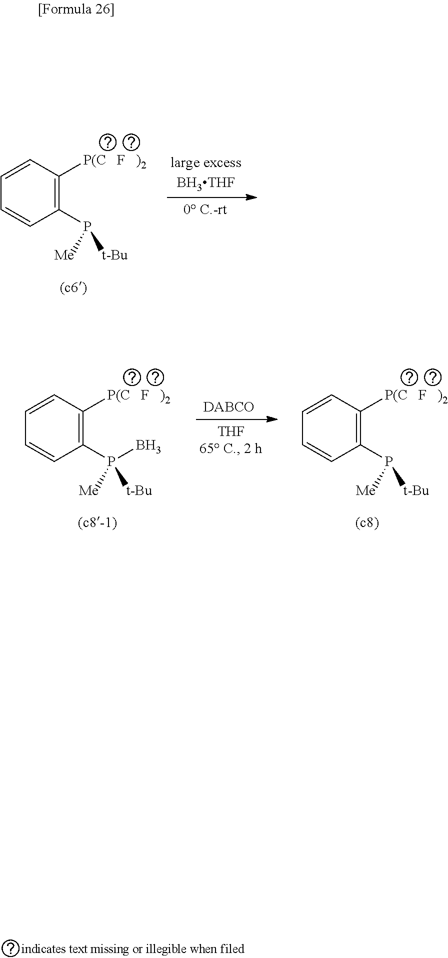

Then, the crude compound (c6′) was refined as follows.

The reaction vessel was dipped in an ice bath, and a borane-THF solution (13 mmol) was added to the reaction liquid containing the crude compound (c6′) by a syringe. Brine was added to the resultant reaction mixture, which was then extracted with ethyl acetate. The extract was washed with brine, and dried with anhydrous sodium sulfate; and thereafter, the solvent was removed by an evaporator. A 1:1 mixed solvent of ethyl acetate and hexane was added to the resultant residue, and well stirred; and thereafter, a white precipitate was filtered and removed. The filtrate was concentrated and vacuum dried to thereby obtain a light yellow amorphous solid (1.52 g). This product was refined by silica gel column chromatography (silica gel: 70 g, developing solvent: ethyl acetate:hexane=1:4) to thereby obtain (R)-1-(boranato)-tert-butylmethylphosphino-2-bis(pentafluorophenyl)phosphinobenzene (c6′-1) as a colorless amorphous solid. The yield amount was 1.10 g, and the yield was 66%.

(Identification Data of the Compound (c6′-1))
R_{f}=0.37 (AcOEt:hexane=1:7)
¹H NMR (500 MHz, CDCl₃) δ 0.4-1.3 (br q, 3H), 1.25 (d, ³J_{HP}=14.4 Hz, 9H), 1.71 (d, ²J_{HP}=9.2 Hz, 3H), 7.48-7.57 (m, 3H), 7.76-7.83 (m, 1H).
¹³C NMR (125 MHz, CDCl₃) δ 10.3 (dd, J_{CP}=38.4, 8.4 Hz), 25.9, 30.6 (d, J_{CP}=29.8 Hz), 128-149 (m).
³¹P NMR (200 MHz, CDCl₃) δ −42.7, 32.2.
¹⁹F NMR (470 MHz, CDCl₃) δ −160.7, −159.1, −150.3, −148.4, −129.9, −128.9.

The (R)-1-(boranato)-tert-butylmethylphosphino-2-bis(pentafluorophenyl)phosphinobenzene (c6′-1)(28 mg, 0.05 mmol) and DABCO (11 mg, 0.1 mmol) were charged in a 10-mL two-necked flask installed with a three-way cock and a septum; vacuumizing and argon introduction were repeated to replace the system interior by argon. Dehydrated THF (0.5 mL) was added, and thereafter, the flask was dipped in an oil bath of 60 to 65° C. to cause the resultant to react for 30 min. After the finish of the reaction, most of the solvent was removed by a diaphragm, and thereafter, the resultant residue was dried by a vacuum pump to thereby obtain (R)-1-tert-butylmethylphosphino-2-bis(pentafluorophenyl)phosphinobenzene (c6). The yield amount was 24 mg, and the yield was 87%.

(Identification Data of the Compound (c6))
R_{f}=0.80 (AcOEt:hexane=1:7)
¹H NMR (500 MHz, CDCl₃) δ 1.09 (d, ³J_{HP}=12.1 Hz, 9H, C(CH₃)₃), 1.21 (d, ²J_{HP}=4.0 Hz, 3H, PCH₃), 7.10-7.13 (m, 1H), 7.28-7.56 (m, 3H).
¹³C NMR (125 Mz, CDCl₃) δ 5.7 (dd, J_{CP}=19.1, 8.4 Hz), 27.1 (d, J_{CP}=15.5 Hz), 30.3 (d, J_{CP}=10.7 Hz), 128-149 (m).
³¹P NMR (200 MHz, CDCl₃) δ −49.8 (d, quin, ³J_{PP}=206 Hz, ³J_{PF}=31.0 Hz), −22.2 (d, ³J_{PP}, =206 Hz).
¹⁹F NMR (470 MHz, CDCl₃) δ −161.3, −159.7, −151.1, −149.5, −129.6, −128.7.

1. A method for producing a phosphinobenzene borane derivative, the method comprising a reaction step (A) of:
obtaining liquid A comprising a 1,2-dihalogenobenzene represented by the following general formula (1): 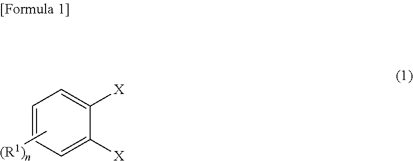
wherein X denotes a halogen atom; R¹ denotes a monovalent substituent; and n denotes an integer of 0 to 4;
obtaining liquid B comprising a phosphine borane compound obtained by deprotonating a hydrogen-phosphine borane compound represented by the following general formula (2): 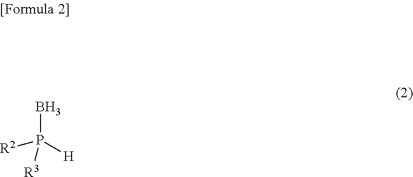
wherein R² and R³ each denote a straight-chain or branched-chain alkyl group having 1 to 10 carbon atoms which may be substituted, a cycloalkyl group which may be substituted, or a phenyl group which may be substituted; and R² and R³ may be the same or different; and
then adding the liquid B to the liquid A to be allowed to react to thereby obtain the phosphinobenzene borane derivative represented by the following general formula (3): 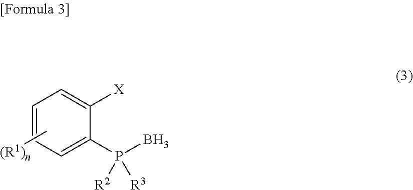
wherein R¹, R², R³, X and n have the same meanings as defined above.

2. The method for producing a phosphinobenzene borane derivative according to claim 1, wherein the hydrogen-phosphine borane compound represented by the general formula (2) is an optically active substance having an asymmetric center on the phosphorus atom.

3. The method for producing a phosphinobenzene borane derivative according to claim 1, wherein R² is a t-butyl group, a 1,1,3,3-tetramethylbutyl group or an adamantyl group; and R³ is a methyl group.

4. The method for producing a phosphinobenzene borane derivative according to claim 2, wherein a reaction temperature in the reaction step (A) is −80 to 30° C.

5. A method for producing a 1,2-bis(dialkylphosphino)benzene derivative, the method comprising:
a reaction step (A) of:
obtaining liquid A comprising a 1,2-dihalogenobenzene represented by the following general formula (1): 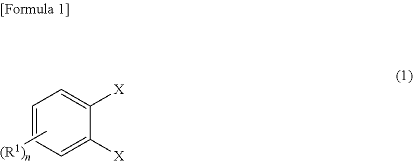
wherein X denotes a halogen atom; R¹ denotes a monovalent substituent; and n denotes an integer of 0 to 4;
obtaining liquid B comprising a phosphine borane compound obtained by deprotonating a hydrogen-phosphine borane compound represented by the following general formula (2): 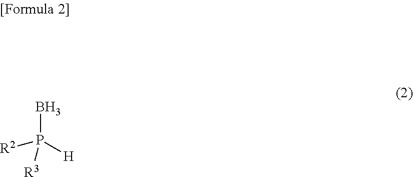
wherein R² and R³ each denote a straight-chain or branched-chain alkyl group having 1 to 10 carbon atoms which may be substituted, a cycloalkyl group which may be substituted, or a phenyl group which may be substituted; and R² and R³ may be the same or different; and
then adding the liquid B to the liquid A to be allowed to react to thereby obtain a phosphinobenzene borane derivative represented by the following general formula (3): 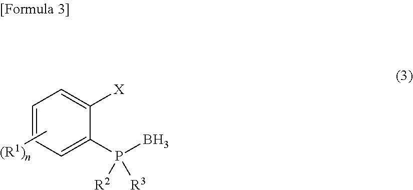
wherein R¹, R², R³, X and n have the same meanings as defined above; and
the following reaction step (B1), reaction step (B2) or reaction step (B3) of obtaining the 1,2-bis(dialkylphosphino)benzene derivative represented by the following general formula (6): 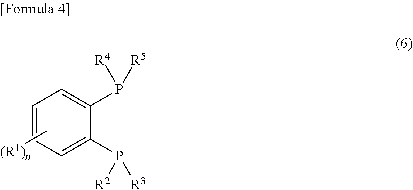
wherein R¹, R², R³, X and n have the same meanings as defined above; and R⁴ and R⁵ each denote a straight-chain or branched-chain alkyl group having 1 to 10 carbon atoms which may be substituted, a cycloalkyl group which may be substituted, or a phenyl group which may be substituted; and R⁴ and R⁵ may be the same or different
by carrying out the reaction step (B1), the reaction step (B2) or the reaction step (B3):
the reaction step (B1): a step of deboranating the phosphinobenzene borane derivative represented by the general formula (3), then lithiating the resultant, then reacting the resultant with an alkyldihalogenophosphine represented by the general formula (4):
R^{a}PX¹₂ (4)
wherein R^{a} is one of R⁴ and R⁵ in the general formula (6); and X¹ denotes a halogen atom, and then reacting the resultant with a Grignard reagent represented by the general formula (5):
R^{b}MgX² (5)
wherein R^{b} is the other of R⁴ and R⁵ in the general formula (6); and X² denotes a halogen atom;
the reaction step (B2): a step of deboranating the phosphinobenzene borane derivative represented by the general formula (3), then lithiating the resultant, then reacting the resultant with a dialkylhalogenophosphine represented by the general formula (4′):
R^{c}₂PX³ (4′)
wherein R^{c} is a group equivalent to R⁴ and R⁵ in the case of being the same in the general formula (6); and X³ denotes a halogen atom:
the reaction step (B3): a step of lithiating the phosphinobenzene borane derivative represented by the general formula (3), then reacting the resultant with a dialkylhalogenophosphine represented by the general formula (4′):
R^{c}₂PX³ (4′)
wherein R^{c} is a group equivalent to R⁴ and R⁵ in the case of being the same in the general formula (6); and X³ denotes a halogen atom, and then deboranating the resultant.

6. The method for producing a 1.2-bis(dialkylphosphino)benzene derivative according to claim 5, wherein the hydrogen-phosphine borane compound represented by the general formula (2) is an optically active substance having an asymmetric center on the phosphorus atom.

7. An (R)-1-dialkylphosphino-2-diphenylphosphinobenzene, represented by the following general formula (7): 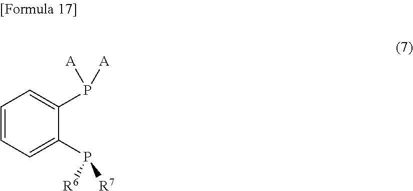
wherein R⁶ and R⁷ each denote a straight-chain or branched-chain alkyl group having 1 to 10 carbon atoms which may be substituted, or a cycloalkyl group which may be substituted, provided R⁶ and R⁷ are not the same group; and A denotes a phenyl group which may be substituted.

8. (R)-1-tert-butylmethylphosphino-2-diphenylphosphinobenzene, represented by the following general formula (8):

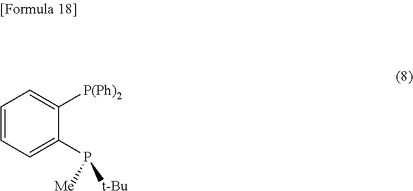

9. An (R)-dialkylphosphino-2-bis(pentafluorophenyl)phosphinobenzene, represented by the following general formula (9): 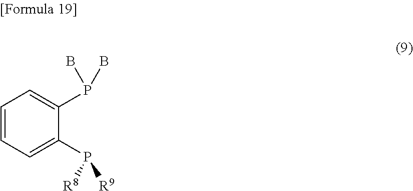
wherein R⁸ and R⁹ each denote a straight-chain or branched-chain alkyl group having 1 to 10 carbon atoms which may be substituted, or a cycloalkyl group which may be substituted, provided R⁸ and R⁹ are not the same group; and B denotes a pentafluorophenyl group which may be substituted.

10. (R)-1-tert-butylmethylphosphino-2-bis(pentafluorophenyl)phosphinobenzene, being represented by the following general formula (10):

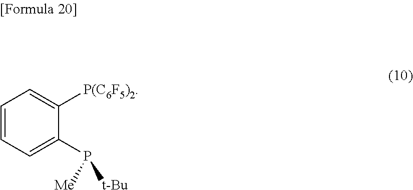

11. A transition metal complex, comprising: a transition metal; and a compound according to claim 7 coordinating to the transition metal.

12. The transition metal complex according to claim 11, being used as a catalyst in an asymmetric synthesis reaction.

13. A transition metal complex, comprising: a transition metal; and a compound according to claim 8 coordinating to the transition metal.

14. A transition metal complex, comprising: a transition metal; and a compound according to claim 9 coordinating to the transition metal.

15. A transition metal complex, comprising: a transition metal; and a compound according to claim 10 coordinating to the transition metal.

16. The transition metal complex according to claim 13, being used as a catalyst in an asymmetric synthesis reaction.

17. The transition metal complex according to claim 14, being used as a catalyst in an asymmetric synthesis reaction.

18. The transition metal complex according to claim 15, being used as a catalyst in an asymmetric synthesis reaction.
